(19) United States
(12) Patent Application Publication
(10) Pub. No.: US 2023/0331873 A1
(43) Pub. Date: Oct. 19, 2023

(54) METHOD FOR MODIFYING POLYSACCHARIDE MATERIAL BY SEQUENCED HOMOGENEOUS CHEMICAL FUNCTIONALISATION

(71) Applicant: ROQUETTE FRERES, Lestrem (FR)

(72) Inventors: Solène BOCK, LAMBERSART (FR); Vincent WIATZ, PREMESQUES (FR); Thomas GUGLIELMETTI, LILLE (FR); Joffrey ATTARD, LILLE (FR)

(21) Appl. No.: 18/113,772

(22) Filed: Feb. 24, 2023

Related U.S. Application Data
(63) Continuation of application No. 16/956,384, filed on Jun. 19, 2020, now abandoned.

(30) Foreign Application Priority Data
Dec. 22, 2017 (FR) 1763142

(51) Int. Cl. C08B 31/12; C04B 24/38; C04B 28/04; C04B 28/14; C08B 31/00; C08B 31/02

(52) U.S. Cl. CPC C08B 31/12; C04B 24/38; C04B 28/04; C04B 28/14; C08B 31/006; C08B 31/02; C04B 2103/44

(57) ABSTRACT

The present invention concerns a method for modifying a polysaccharide material, preferably an amylaceous material, involving a first step of homogeneous solubilisation of said polysaccharide material in an aqueous solvent, followed by a step of homogeneous chemical functionalisation comprising at least one non-crosslinking chemical modification, or at least one crosslinking chemical modification, or a sequence of at least one non-crosslinking chemical modification and at least one crosslinking chemical modification. Secondly, the present invention concerns a modified polysaccharide material, in particular obtained by the method according to the invention, characterised in that it has a novel distribution of the chemical substituents attached to the hydroxyl functions of the anhydroglucose units of said polysaccharide material. The novel starches can be used as organic adjuvants for dry mortars made from cement or made from gypsum, in particular as a binder for a dry mortar made from cement or as a thickening agent for a mortar made from plaster.

### FIELD OF THE INVENTION

The present invention relates to novel modified starches which are useful as organic adjuvants with binding and thickening properties, for dry mortars, adhesive mortars and spraying plasters.

### BACKGROUND OF THE INVENTION

Physically and chemically modified starches are of great utility in a large number of fields such as, inter alia, papers, plastics, water treatment additives, additives for construction materials, pharmaceuticals, cosmetics, and human or animal nutrition. It is known that modifications made to starch give it working properties that can be adjusted by means of the physical modification process and by means of the chemical nature of the chemical modifications.

The term “physical functionalization” is generally applied when the starch acquires working properties by means of a mechanical and/or heat treatment; and the term “chemical functionalization” is generally applied when they are acquired by replacing the hydroxyls of starch with molecules bearing functional groups that are not naturally present on starch.

The developments in the chemical functionalization of starches are essentially focused on the addition of an ever-increasing amount of chemical substituents to the starch, i.e. on achieving high degrees of substitution, and in doing so while circumventing or managing the high viscosity of the aqueous starch solutions resulting from the dissolution of the starch during its chemical modification. By way of illustration, once the degree of substitution reaches a minimum value, which is dependent on the botanical origin of the starch and on the chemical nature of the substituents, which may range from 0.06 (for carboxyalkylations) to more than 0.2 or even 0.5 (for hydroxyalkylations), starch develops a high to very high viscosity, which is proportional to the mass content of starch, which may range from 10000 mPa·s up to more than 100000 mPa·s.

Circumventing the problem of the high viscosity has mainly consisted in using aqueous suspensions of granular starch in the presence of agents for preventing the swelling or the dissolution of the starch grains, such as sodium salts. The chemical modification is then performed on the granular starch, which conserves its granular structure throughout the modification: this will be referred to as granular-phase chemical functionalization. Only the surface or the outer layers of the starch grains are accessible to the modification reagents when the starch is granular. Thus, the chemical modifications are essentially concentrated on a fraction of the starch mass. Relative to the total mass of starch introduced for modification, there is thus clearly a heterogeneous distribution of the chemical functions introduced: this will be referred to as heterogeneous chemical functionalization. The starches thus modified are generally transformed into aqueous solutions before being used, mainly so as to liberate the binding properties of the starch.

When this cannot be avoided, the high viscosity of the aqueous starch solutions is managed by performing crosslinking of the granular starch (U.S. Pat. Nos. 3,014,901, 3,438,913, 2,853,484) or by fluidizing the starch by acid hydrolysis which does not destructure the starch grain, and doing so before the dissolution of the starch has commenced. These two modifications of starch bring about changes in the macromolecular structure of the starch, in terms of molecular weight and/or branching of the polymer chains, and in the structure of the intermolecular network between the constituent macromolecules of the starch. Crosslinking increases the molecular weight by creating intermolecular bonds, whereas fluidization reduces it by breaking saccharide bonds.

In both cases, during the chemical modifications of these crosslinked or fluidized granular starches, some of the chemical modification takes place on a granular starch, until the degree of substitution reaches the value at which the starch becomes dissolved, and is then continued until the target degree of substitution is reached. The dissolution which arises during such a chemical modification generally leads to an aqueous dispersion of starch, or starch paste, in very varied states, namely: intact starch grain, partially swollen starch grain, totally swollen starch grain, fragments of swollen grains, swollen starch aggregates, dissolved starch macromolecules and precipitated retrograded starch. This will be referred to as mixed-phase chemical functionalization, which means that the state of the starch is intermediate between a granular starch and a dissolved starch.

Thus, an important proportion, or at least a non-negligible proportion, of the chemical modification is located on the surface or the outer layers of the starch grains or of the starch grain fragments, which represents only a fraction of the theoretical mass of starch available for modification. As for granular-phase chemical modification, mixed-phase chemical modification leads to a heterogeneous distribution of the chemical functions on the mass of starch.

Furthermore, in both cases, it should be noted that the sole purpose of modifying the macromolecular structure of starch is to reduce the viscosity of the aqueous starch solution so as to make it manipulable, and does not contribute toward the desired working property.

In the field of plaster-based or cement-based mortars, modified starches are used as organic adjuvants to improve the application properties of these mortars, such as the shelf life, the standing time, the pot life, the open time, the wetting power, the sliding resistance, the adjustability; or the final performance qualities, such as the adhesion, the deformability, the transverse deformation or the breaking strength.

In order to satisfy these properties or performance qualities, starches are generally chemically modified according to modifications to individual values with a degree of substitution of greater than 0.2 and even being up to 0.8; which corresponds to total degree of substitution values of between 1 and 1.5. These modifications are essentially hydroxyalkylation, such as hydroxypropylation; carboxyalkylations, such as carboxymethylation; and finally crosslinkings, such as those performed with sodium trimetaphosphate.

To achieve these degrees of substitution, and on account of the moderate reaction yields, of the order of 60-80%, granular-phase or mixed-phase processes must use excess amounts of reagents. Furthermore, side reactions transform the modification reagents into undesired products, which represent, at best, losses of material giving rise to an increased production cost, and, at worst, impurities which have a negative impact on the working properties, and, needless to say, waste products to be treated, which may represent an environmental contamination. In the case of hydroxypropylation, a considerable portion of the propylene oxide is thus lost as ethylene glycol and polyethylene glycols, and, as regards carboxymethylation, a major side product is propanediol.

An ideal modified starch would thus be a starch having just the right amount of chemical substituents, so as to reduce the losses and the pollution products, while at the same time maintaining the working properties. This problem is solved by the process that is the subject of the present invention.

### SUMMARY OF THE INVENTION

In contrast with heterogeneous or mixed-phase chemical modifications, the subject of the present invention is a process of chemical modification on a perfectly, or substantially, totally dissolved starch, in order to distribute the chemical modifications homogeneously over the entire available mass of starch. This functionalization according to the invention will be termed homogeneous chemical functionalization.

By means of this homogeneous chemical functionalization, novel starches are obtained. They may be characterized by measuring the positions of the chemical substituents on the anhydroglucose units. Such a measurement may be performed by proton nuclear magnetic resonance.

The Applicant has observed, surprisingly and unexpectedly, that by performing a homogeneous chemical functionalization according to the sequence consisting of a first homogeneous chemical functionalization by chemical modifications of etherification or esterification type not consisting of crosslinking, and followed by a second homogeneous chemical functionalization consisting of crosslinking, liquid or solid modified starches may be prepared so as to have satisfactory or even improved thickening, binding or flocculant properties, despite having lower degrees of substitution than those of modified starches prepared according to the granular-phase or mixed-phase processes of the prior art.

Furthermore, by completely dissolving the polysaccharide material to form a perfectly homogeneous aqueous solution, in a controlled manner, an additional improvement is possible.

Process:

A first subject of the present invention is a process for modifying a polysaccharide material, consisting of an ordered sequence of at least two modifications: the first is perfectly homogeneous, preferentially complete dissolution of the polysaccharide material in water; the second is homogeneous chemical functionalization, which consists of at least one non-crosslinking chemical modification, or at least one crosslinking chemical modification, or a combination of at least one of these two chemical modifications.

The term “homogeneous chemical functionalization” refers to a process of chemical modification on a perfectly, in other words totally, dissolved starch, so as to distribute the chemical modifications homogeneously over the entire available mass of starch.

The present invention relates to a process for modifying a polysaccharide material, preferably including anhydroglucose units, comprising substantially total, preferentially total, dissolution of this polysaccharide material, and homogeneous chemical functionalization of the dissolved polysaccharide material, characterized in that
a. the dissolution is performed before the chemical functionalization,
b. the functionalization comprises at least one chemical modification chosen from non-crosslinking chemical modifications, or from crosslinking chemical modifications, or a sequence of at least one non-crosslinking chemical modification and of at least one crosslinking chemical modification.

The process for modifying a polysaccharide material according to the invention may also be characterized in that the dissolution is performed by heating in a stirred tank in the presence of a base.

The process for modifying a polysaccharide material according to the invention may also be characterized in that the homogeneous chemical functionalization comprises at least one etherification or at least one esterification, or at least one etherification and at least one esterification.

According to one variant of the process according to the invention, the etherifications are performed before the esterifications. The etherifications of the process according to the invention may be chosen from hydroxyalkylations, carboxyalkylations or cationizations.

The process for modifying a polysaccharide material according to the invention may also be characterized in that the hydroxyalkylation is a hydroxypropylation, and in that it is performed until a degree of substitution ranging from 0.05 to 2, preferentially from 0.1 to 1, most preferentially from 0.15 to 0.6 and more preferentially from 0.15 to 0.5 is reached.

The process for modifying a polysaccharide material according to the invention may also be characterized in that the functionalization comprises a non-crosslinking chemical modification, a hydroxyalkylation, preferably hydroxypropylation, performed until a polysaccharide material having a degree of substitution of between 0.05 and 2, preferentially between 0.1 and 1, most preferentially between 0.15 and 0.6 and more preferentially from 0.15 to 0.5 is reached.

The process for modifying a polysaccharide material according to the invention may also be characterized in that the functionalization comprises a second non-crosslinking chemical modification, a carboxyalkylation, preferably a carboxymethylation, performed until a polysaccharide material having a degree of substitution of between 0.03 and 2, preferentially between 0.03 and 1, most preferentially between 0.03 and 0.3 and more preferentially from 0.03 to 0.2 is reached.

The process for modifying a polysaccharide material according to the invention may also be characterized in that the carboxyalkylation is a carboxymethylation, and in that it is performed until a degree of substitution ranging from 0.03 to 2, preferentially from 0.03 to 1, most preferentially from 0.03 to 0.3 and more preferentially from 0.03 to 0.2 is reached.

The process for modifying a polysaccharide material according to the invention may also be characterized in that the esterifications are chosen from carboxyalkylations.

The process for modifying a polysaccharide material according to the invention may also be characterized in that the homogeneous chemical functionalization comprises at least one crosslinking chemical modification with a short-distance crosslinking agent (or short-chain crosslinking agent), or a long-distance crosslinking agent (or long-chain crosslinking agent), or a long-distance crosslinking system, or a combination of at least two of these three types of crosslinking agents.

The process for modifying a polysaccharide material according to the invention may also be characterized in that the long-distance crosslinking system consists of at least one polyhydroxylated polymer and of at least one short-distance crosslinking agent. The process for modifying a polysaccharide material according to the invention may also be characterized in that the short-distance crosslinking agent (or short-chain crosslinking agent) is a molecular polyfunctional reagent including from 8 to 30 atoms, and is used at a dose ranging from 100 ppm to 10000 ppm, preferentially from 500 ppm to 5000 ppm.

The process for modifying a polysaccharide material according to the invention may also be characterized in that the short-distance crosslinking agent is sodium trimetaphosphate.

The process for modifying a polysaccharide material according to the invention may also be characterized in that the chemical functionalization comprises a third and final chemical modification chosen from crosslinking chemical modifications.

The process for modifying a polysaccharide material according to the invention may also be characterized in that the homogeneous chemical functionalization comprises at least a third and final crosslinking chemical modification with a short-distance crosslinking agent, and in that the short-distance crosslinking agent is a molecular polyfunctional reagent including from 8 to 30 atoms, preferentially sodium trimetaphosphate, used at a dose of between 100 ppm and 10000 ppm, preferentially between 500 ppm and 5000 ppm.

The process for modifying a polysaccharide material according to the invention may also be characterized in that it consists of: firstly, a hydroxypropylation, preferably to a degree of substitution ranging from 0.15 to 0.5; secondly, a carboxymethylation, preferentially to a degree of substitution ranging from 0.05 to 0.2; and thirdly a short-distance crosslinking with sodium trimetaphosphate, preferentially to a dose ranging from 500 ppm to 5000 ppm.

The process for modifying a polysaccharide material according to the invention may also be characterized in that it includes a final step of placing in a solid form, comprising drying, milling and screening.

The process for modifying a polysaccharide material according to the invention may also be characterized in that the polysaccharide material consists of at least one native starch, or of a mixture of at least two native starches of different botanical origins.

Product:

A second subject of the present invention is a modified polysaccharide material including anhydroglucose units, preferentially a modified starch, which is totally water-soluble, the hydroxyl functions of said anhydroglucose units being substituted with at least one hydroxyalkyl chemical group and characterized in that the hydroxyalkyl groups substituting the hydroxyl functions are distributed in the following manner:
at most 68%, preferentially at most 65%, very preferentially at most 64% in position 2,
and/or at least 15%, preferentially at least 17%, very preferentially at least 17.5% in position 3,
and/or at least 15%, preferentially at least 17%, very preferentially at least 18% in position 6,
the sum of the percentages of the hydroxyalkyl groups substituting the hydroxyl functions being equal to 100% and these percentages being measured by proton NMR.

According to one variant of the modified polysaccharide material according to the invention, preferentially a modified starch, the hydroxyl functions of said anhydroglucose units are substituted with at least one carboxyalkyl chemical group and characterized in that the carboxyalkyl groups substituting the hydroxyl functions are distributed in the following manner:
at least 75.5%, preferentially at least 76.5% in position 2,
and/or at most 20%, preferentially at most 19% in position 3,
and/or at least 4%, preferentially at least 5% in position 6,
the sum of the percentages of the carboxyalkyl groups substituting the hydroxyl functions being equal to 100% and these percentages being measured by proton NMR.

The invention relates to a modified starch in powder form, which is soluble in cold water, preferentially at least 95% amorphous, more preferentially at least 98% amorphous and most preferentially totally amorphous, characterized in that it is obtained via a process according to the invention.

The invention relates to a modified starch obtained according to the process according to the invention, characterized in that it has a volume-mean diameter, measured by dry-route laser scattering, ranging from 10 μm to 1 mm, preferentially ranging from 50 μm to 500 μm.

The invention also relates to the use of these novel starches as additives for construction materials, preferentially gypsum-based or cement-based materials.

One subject of the present invention is the use of at least one starch obtained via the process according to the invention as a binder in a cement mortar.

One subject of the present invention is the use of at least one starch obtained via the process according to the invention as an organic adjuvant in a dry mortar composition, preferentially a dry mortar for tile adhesive, and most preferentially a mortar for ceramic tile adhesive.

One subject of the present invention is the use of at least one starch obtained via the process according to the invention as an organic adjuvant in a cement mortar adhesive, characterized in that the ratio of the mass of water to the mass of cement is greater than 0.60, preferentially greater than or equal to 0.70.

One subject of the present invention is a dry mortar comprising the following ingredients:
one or more hydraulic binders,
one or more fillers,
one or more thickeners,
one or more redispersible powders,
one or more modified starches,
characterized in that said modified starch(es) are according to the process according to the invention.

One subject of the present invention is a dry mortar comprising, in percentages by dry weight:
from 20% to 45% of hydraulic binder,
from 50% to 70% of fillers,
from 0.2% to 1% of thickeners,
from 0.5% to 5% of redispersible powder,
from 0.01% to 1% of modified starches,
characterized in that said modified starch(es) are according to the process according to the invention, the sum of the percentages being equal to 100%.

One subject of the present invention is the use of at least one starch obtained via the process according to the invention in a gypsum-based mortar, preferentially in a spraying plaster or in a plasterboard plaster.

One subject of the present invention is the use of at least one starch obtained via the process according to the invention as a thickener in a gypsum-based mortar.

### DETAIL OF THE INVENTION

One subject of the present invention is a process for modifying a polysaccharide material, known as a “sequenced homogeneous functionalization process”, for the purpose of obtaining a chemically modified polysaccharide composition, optionally placed in the form of a powder, which is preferentially amorphous. A second subject of the invention is the modified polysaccharide material thus obtained. A final subject of the invention is the use of this novel modified polysaccharide material as an organic adjuvant in gypsum-based or cement-based dry mortars, notably as a binder and thickener in such mortars.

A subject of the present invention is also a polysaccharide material having specific substituent group distributions. This polysaccharide material may be obtained via the process that is the subject of the present patent application.

The adhesive-phase modification process comprises a first step consisting of at least one hydrothermal modification of the “base” polysaccharide material to totally, or substantially totally, dissolve said material in an aqueous phase. By the term “base”, the Applicant means the polysaccharide material which is subjected to the modification process according to the invention. This dissolution is performed so as to obtain a perfectly homogeneous aqueous solution. According to one variant of the invention, the base polysaccharide material consists of one or more native starches and/or native starch derivatives obtained by physical modification of one or more starches.

Next, during a second step, the dissolved polysaccharide material is chemically modified according to a homogeneous chemical functionalization comprising at least one non-crosslinking chemical functionalization, or at least one crosslinking chemical functionalization, or at least one non-crosslinking chemical functionalization and at least one crosslinking chemical functionalization. The crosslinking chemical functionalization may be performed with at least one short-distance or long-distance crosslinking agent, or with at least one crosslinking system consisting of a short-distance crosslinking agent and a polyhydroxylated polymer.

Finally, the modified polysaccharide material is transformed into a substantially amorphous powder via a drying and optional milling operation. The powder thus obtained is soluble without heating.

When it is prepared from starch, preferentially native starch, the modified starch powder according to the process of the invention is an excellent organic binder which is useful for cement-based or gypsum-based dry mortars, and plasters. In cement-based adhesive mortars, they offer excellent slip resistance, equivalent to the best commercial products available. In plaster mortars for plasterboards or spraying plasters, they offer good resistance to spreading, and allow acceptable core reinforcement.

Compared with commercial products such as Amitrolit® 8850 from Emsland or the products Casucol® 301 or Casucol® Fix1 from Avebe, the modified starches according to the process of the invention have lower degrees of substitution, while at the same time having maintained or even improved working properties. These lower degrees of substitution imply a process consuming a smaller amount of toxic starting materials, notably less alkylene oxides, such as propylene oxide, and discharging a smaller amount of undesirable side products, such as ethylene glycol, polyethylene glycol or propanediol. The carbon footprint of the product according to the invention is markedly improved relative to those of the current commercial products.

The prior art mentions in general terms the possibility of performing several substitutions of different chemical groups onto the same base starch, but does not reveal any particular combinations and, all the less so, any particular combination for achieving binding, thickening and flocculant functionalities.

Without being limited by a theory, the Applicant estimates that the excellent slip resistance properties result from a homogeneous statistical distribution of the substituent chemical groups on the gelatinized starch chains, relative to the products of the prior art. This is probably permitted by the total and homogeneous, or substantially total and homogeneous, dissolution of the native starch prior to the chemical substitutions.

Base Polysaccharide Material

The process according to the invention may be applied to polysaccharides in general. The term “base polysaccharide material” will denote any type of polysaccharide that may be engaged in the process according to the invention.

According to one variant of the process of the invention, this base polysaccharide material is a starchy material, i.e. a material consisting of native starch and/or of native starch derivatives obtained by physical modifications.

The base starchy material may consist of at least one native starch, which may be starch from a cereal, such as wheat, corn, waxy corn, amylopectin-rich corn or rice; a starch from a leguminous plant, such as pea or soybean; or a starch from a tuber, such as potato.

One variant of base starchy material may be a mixture of at least two starches of the same botanical variety, or a mixture of at least two starches of different botanical varieties, such as cereal/legume, cereal/tuber or tuber/legume.

The varieties of these amylopectin-rich starches, i.e. starches containing more than 95% of amylopectin, or amylose-rich starches, i.e. starches containing more than 95% of amylose, may also constitute the base starchy material.

Another variant of base starchy material may be a mixture of at least two starches with different amylopectin or amylose contents, such as amylopectin-rich/amylose-rich.

Another variant of base starchy material consists of at least one native starch and of at least one native starch which has been depolymerized by means of at least one chemical, enzymatic or heat treatment. The heat-treated native starch may be a white dextrin, a yellow dextrin or a “British gum” dextrin. The enzymatically treated native starch may be a maltodextrin. The chemically treated native starch may be a native starch which has been fluidized by means of an acid treatment. The native starch and the starch derivative may be of different botanical origin.

Other variants of base polysaccharide material are polysaccharide hydrocolloids such as native cellulose, guar gum, xanthan gum, cassia gum or carrageenans, used individually or as a mixture.

Steps of the Modification Process

Homogeneous Dissolution by Hydrothermal Modification

The first step of the modification process according to the invention consists of homogeneous dissolution of the base polysaccharide material by means of at least one hydrothermal modification, to obtain a homogeneous aqueous solution of polysaccharide material, free of any granular structure or grain residues.

This first step must be performed prior to the subsequent homogeneous chemical functionalization, i.e. before all the subsequent chemical modifications, so as to ensure equivalent accessibility of all the mass of polysaccharide material.

Without being bound by a theory, the Applicant estimates that, thus, all or substantially all of the substitutable hydroxyl groups borne by the polysaccharide material are available and accessible to the chemical reagents in an equivalent manner relative to each other. The resistance to material transfer so that the reagents gain access to the hydroxyls is thus equivalent for all the available substitutable hydroxyls.

According to one variant of the invention, the first step of the process is a hydrothermal modification of the base starchy material, which allows the transformation of the physical state of this material, passing from a granular structure to a hydrocolloid structure, under the action of the temperature in aqueous medium, optionally at a basic pH. This destruction of the granular structure of the starch is obtained by splitting the starch grains by means of the techniques that are well known to those skilled in the art: steam cooking with a nozzle, heat treatment in basic medium in a stirred tank, and doing so in a batchwise or continuous manner.

The hydrothermal modification transforms the starchy material into a substantially totally dissolved state. This means that observation under a light microscope of a sample of this solution in polarized light will show the total or virtually total absence of the characteristic birefringence crosses of starch grains, and also the total or virtually total absence of “ghosts” of partially swollen or split grains.

If the mass content of dry polysaccharide material exceeds a value typically between 1% and 5% of the total mass of aqueous solution of polysaccharide material, the dissolution leads to the formation of a gel. According to a preferential embodiment, the base starchy material is dissolved in water to a mass content of dry base starchy material ranging from 5% to 60% of the total mass of aqueous dispersion, preferentially ranging from 20% to 40%. For these mass contents of base starchy material, the hydrothermal modification gives a gel of starchy material: this is a gelatinization.

According to another preferential embodiment, the dissolution is performed by heating an aqueous dispersion of base starchy material in a stirred heat exchanger, such as a stirred jacketed tank, at a temperature greater than or equal to the gelatinization temperature of the starchy material plus 5° C., preferentially 10° C. Furthermore, the dissolution is catalyzed by adding a base to a content of greater than or equal to 0.5% of dry base relative to the dry starchy material, denoted as dry/dry, preferentially greater than or equal to 1% dry/dry. The base may be sodium hydroxide, potassium hydroxide or any other salt which provides hydroxide ions.

On conclusion of the dissolution, the colloidal solution of native starchy material obtained generally has a Brookfield viscosity, measured at 20° C. and 20 rpm, ranging from 10000 mPa·s to 100000 mPa·s, preferentially from 50000 mPa·s to 75000 mPa·s.

Chemical Functionalization by Substitution of the Hydroxyls

The dissolved native polysaccharide material is then transformed into homogeneously chemically modified polysaccharide material. This step, termed homogeneous chemical functionalization, consists of chemical substitution of the hydroxyl functional groups, while maintaining perfect or virtually perfect mixing of the reaction mass. The chemical substitution reactions are chosen from etherifications, esterifications and radical graftings, consisting of a chemical functionalization, and above all not consisting either of crosslinking or of cleavage of the bonds of the backbone of the constituent polysaccharides of the polysaccharide material.

The aim of the homogeneous chemical functionalization is to attach nonionic or ionic functional groups in a uniform distribution on the mass of polysaccharide material, and all the more so on the constituent macromolecular chains of the polysaccharide material.

The functional groups provided by the chemical substituents are alcohols, acids, amines or alkylammoniums. In a manner that is known per se, these functional groups allow interactions by hydrogen bonding or by electrostatic bonding between the polysaccharide material and organic substrates, such as cellulose or derivatives thereof, or mineral substrates, such as lime, silica or alumina particles, such as limestone, clay, cement or gypsum particles.

However, surprisingly, the homogeneous chemical functionalization according to the invention gives the polysaccharide material a better capacity to interact with these substrates. A smaller amount of substituents makes it possible to obtain a result equivalent to that of the products of the prior art containing a substantially larger amount.

The homogeneous distribution of the chemical functions introduced onto the polysaccharide material is permitted by means of the state of perfect or virtually perfect mixing of the reaction mass. This state of mixing enables the majority of the reagents to be dispersed in the reaction mass before being able to react with the polysaccharide material.

The reagents that are useful for the homogeneous chemical functionalization are monofunctional reagents that are capable of forming an ether or ester bond with an alcohol functional group. By the term “monofunctional”, the Applicant means that the reagent is a molecule, or macromolecule, bearing at least one chemical function, only one of which is capable of reacting with an alcohol function of the polysaccharide material, with or without catalysis. The homogeneous chemical functionalization does not induce any modification of the order of magnitude of the molecular weight of the polysaccharide material.

In general, these reactions may be performed in any order. According to one variant of the process of the invention, the etherification(s) are performed before the esterification(s).

The contents of reagents to be used are chosen such that the resulting polysaccharide material has the desired degree of substitution values for each type of substituent according to the invention. A person skilled in the art will know how to adjust the reaction conditions so as to obtain these degrees of substitution.

Stirring Conditions for a Perfect or Virtually Perfect Mixture By the term “virtually perfect mixture”, the Applicant means states of mixture mainly characterized by a good macromixture, i.e. homogeneous distribution of the reaction material in the reaction volume, and notably without any dead zones or stagnation zones. Such a mixture is characterized in that the concentration of a compound has virtually the same value at any point in the reactor.

Additionally, a perfect mixture also has a good micromixture, i.e. a good mixture inside the circulation zones created by the macromixture.

A person skilled in the art of chemical reaction engineering knows how to obtain this state of mixture with stirring devices suitable for viscous media. The Applicant refers to reference publications of the “Techniques de l'ingénieur [Engineering Techniques]” series such as “Mélange des milieux pâteux de rhéologie complexe. Théorie [Mixing of pasty media of complex rheology. Theory]” J 3 860 and “Mélange des milieux pâteux de rhéologie complexe. Pratique [Mixing of pasty media of complex rheology. Practice]” J 3 861, both written by H. Desplanches and J-L. Chevalier.

In general terms, producing a perfect mixture is possible by means of a suitable stirring device and a sufficient mixing time. However, the cost of such devices or the mixing time may be too high or too long for industrial exploitation to be viable. It often proves to be sufficient to achieve virtually perfect mixing in which a major proportion of the reaction mass is perfectly mixed, and a minor proportion of this reaction mass is not mixed.

Non-Crosslinking Homogeneous Chemical Functionalization

Etherifications

According to one variant of the process of the invention, the etherifications are chosen from hydroxyalkylations, carboxyalkylations or cationizations starting with nitrogenous reagents, and these reactions are performed on a polysaccharide material which is a starchy material.

The hydroxyalkylations that are useful in the invention are those whose function is to introduce carbon-based chains with a length ranging from 2 to 10 carbon atoms, preferentially from 3 to 5 carbon atoms, and bearing at least one alcohol function, preferentially from among hydroxypropylation or hydroxyethylation.

Generally, ether functions of hydroxypropyl type are introduced onto the starch by reacting it with propylene oxide, or epoxypropane, optionally in the presence of a basic catalyst, such as sodium hydroxide. According to the invention, the hydroxypropylated starch has a degree of substitution with hydroxypropyl function ranging from 0.05 to 2, preferentially from 0.1 to 1, most preferentially ranging from 0.15 to 0.6 and more preferentially ranging from 0.15 to 0.5.

The carboxyalkylations that are useful in the invention are those which make it possible to introduce carbon-based chains with a length ranging from 2 to 10 carbon atoms, preferentially from 3 to 5 carbon atoms, and bearing at least one carboxylic acid function, preferentially carboxymethylation.

Usually, ester functions of carboxymethyl type are introduced onto the starch by reacting it with monochloroacetic acid or with sodium monochloroacetate, optionally in the presence of a basic catalyst, such as sodium hydroxide. According to the invention, the starch thus carboxymethylated has a degree of substitution with carboxymethyl function ranging from 0.05 to 2, preferentially from 0.05 to 1, most preferentially ranging from 0.05 to 0.3 and more preferentially ranging from 0.05 to 0.2.

The cationizations that are useful in the invention are those performed with nitrogenous reagents based on tertiary amines or quaternary ammonium salts. Among these reagents, the ones that are preferred are 2-dialkylaminochloroethane hydrochlorides such as 2-diethylaminochloroethane hydrochloride or glycidyltrimethylammonium halides and the halohydrins thereof, such as N-(3-chloro-2-hydroxypropyl)trimethylammonium chloride, the latter being preferred.

Esterifications

According to one variant of the process according to the invention, the esterifications are chosen from those performed with a reagent known as an esterifying agent, including at least two carboxylic acid functions, and are performed on a polysaccharide material which is a starchy material.

The esterifying agents may thus be polycarboxylic acids, or carboxylic acid halides, or polyacid anhydrides, or sulfonated derivatives of these acids. Among these esterifying agents, those with a number of carbon atoms ranging from 2 to 16 and most preferentially ranging from 2 to 5 will be preferred.

Polycarboxylic acids that are useful in the invention are linear dicarboxylic acids having a carbon number ranging from 2 to 10, preferentially ranging from 3 to 5, among which ethanedioic acid, propanedioic acid or butanedioic acid will be preferred. The carboxylic acid halides that are useful in the invention are acetyl chloride and propionyl chloride. The polyacid anhydrides that are useful in the invention may be phthalic anhydride, succinic anhydride or maleic anhydride.

Crosslinking Homogeneous Chemical Functionalization

Crosslinking homogeneous chemical functionalization of the polysaccharide material consists of crosslinking with at least one crosslinking agent under stirring conditions which ensure perfect or virtually perfect mixing. According to one embodiment, the crosslinking agent is a short-distance crosslinking agent: this will then be referred to as short-distance crosslinking. According to another embodiment, the crosslinking agent is a long-distance crosslinking agent or a long-distance crosslinking system: this will then be referred to as long-distance crosslinking. Finally, according to a final embodiment, a combination of short-distance and long-distance crosslinking is performed by combining at least one short-distance crosslinking agent and at least one long-distance crosslinking agent.

The crosslinking agents that are useful for the invention are polyfunctional reagents, i.e. molecules or macromolecules bearing at least two chemical functions, at least two of which are each capable of reacting with a hydroxyl of the polysaccharide material, with or without catalysis, to form an ether or ester bond.

In general, the crosslinking is an etherification or an esterification leading to a modification of the order of magnitude of the molecular weight of the polysaccharide material, by creating bonds between the macromolecular chains of the polysaccharide material. It is generally performed so as to modify the viscosity or the texture of a polysaccharide material.

According to the invention, the crosslinking makes it possible to solidly connect the functionalized polysaccharide chains intermolecularly, by creating intermolecular bridges randomly or homogeneously distributed on the polysaccharide chains, and according to the long-distance crosslinking variants, having chosen lengths.

The crosslinking according to the invention is characterized in that it is performed under stirring conditions which ensure perfect or virtually perfect mixing of all the material introduced into the reactor, known as the reaction mass. The perfect or virtually perfect state of mixing is the same as that in which the homogeneous chemical functionalization presented previously is performed.

According to one variant, this perfect or virtually perfect mixing is achieved at the moment when the reaction starts. According to another variant, it is achieved before the reaction starts.

In theory, the perfect or virtually perfect mixing should ensure a homogeneous distribution of the crosslinking bridges on the macromolecular chains of the polysaccharide material. Without being bound by any theory, the crosslinking conducted in this particular manner quite probably gives the modified polysaccharide material a particular spatial structure, and as such the chemical functions previously attached can interact efficiently with a plant or mineral matrix. It also results therefrom that the degrees of substitution required for obtaining binding or thickening properties are reduced relative to those of the products obtained by heterogeneous or mixed-phase functionalization of the prior art. These properties may also be improved when the degrees of substitution are maintained at values equal to those of the products of the prior art.

In this connection, the crosslinking with the crosslinking system according to the invention also has the effect of increasing the molecular weight of the modified polysaccharide material.

Short-Distance Crosslinking

A first type of crosslinking that is useful for the invention is “short-distance” crosslinking, performed with a short-distance crosslinking agent.

By the term “short-distance crosslinking agent”, the Applicant means molecular polyfunctional organic reagents. By the term “molecular”, the Applicant means: either organic molecules bearing a carbon-based chain, the carbon-based chain of which contains at most 8 carbon atoms, preferentially at most 6 carbon atoms and most preferentially at most 2 carbon atoms; or organic molecules without a carbon-based chain, consisting of 8 to 30 atoms or heteroatoms, preferentially from 10 to 16 atoms or heteroatoms.

The variants of organic molecules that are useful as short-distance crosslinking agents according to the invention are those chosen from polyfunctional acids such as polycarboxylic acids, for instance citric acid, or polyphosphoric acids, for instance triphosphoric acid; polyacid anhydrides, including mixed polyacid anhydrides such as mixed adipic-acetic anhydride; or polyfunctional basic organic molecules; and also the metal salts thereof such as the sodium, manganese, calcium, manganese, iron, copper or zinc salt.

One particular variant of short-distance crosslinking agent that is useful for the invention comprises those chosen from the sodium salts of polyacids, such as sodium trimetaphosphate or sodium tripolyphosphate.

Other variants of short-distance crosslinking agent are: polyfunctional aldehydes, such as glyoxal; halogenated epoxides, such as epichlorohydrin; aliphatic or aromatic diisocyanates, in which the alkyl chain contains less than 8 carbon atoms, such as hexamethylene diisocyanate.

One variant of molecules that are useful as short-distance crosslinking agent is oxohalides, such as phosphorus oxychloride.

As regards its use, the short-distance crosslinking is performed by adding a dose of short-distance crosslinking agent to the chemically functionalized polysaccharide material, with stirring ensuring rapid and homogeneous dispersion of the crosslinking agent in the mass of polysaccharide material, at a temperature of at least 20° C., for a reaction time of at least 60 minutes.

The dose of short-distance crosslinking agent to be used during the crosslinking is expressed as dry mass of crosslinking agent to be introduced into the reaction medium, relative to the dry mass of polysaccharide material initially engaged in the modification process according to the invention. This dose is within a range extending from 100 ppm to 10000 ppm of dry mass of short-distance crosslinking agent relative to the dry mass of polysaccharide material, preferentially in a range extending from 2500 ppm to 5000 ppm.

The short-chain crosslinking agent may be introduced in the form of an aqueous solution containing between 0.5% and 50% by weight of dry crosslinking agent, preferentially between 2% and 20% by weight. This solution must be maintained at a temperature equal to the temperature of the reaction medium.

It is crucial for the solution of crosslinking agent to be rapidly dispersed in the reaction medium as soon as it has been introduced therein. This rapid dispersion is necessary to allow homogeneous distribution of the crosslinking bridges over the entirety of the polysaccharide chains.

According to one variant of the short-distance crosslinking, the temperature of the reaction medium during the short-distance crosslinking is greater than or equal to 35° C., preferentially greater than or equal to 50° C.

According to another variant of the short-distance crosslinking, the reaction time is greater than or equal to 5 hours, preferentially greater than or equal to 10 hours, and most preferentially greater than or equal to 15 hours.

Long-Distance Crosslinking

A second type of crosslinking that is useful for the invention is “long-distance” crosslinking, performed either with a long-distance crosslinking agent or with a long-distance crosslinking system.

By the term “long-distance crosslinking agent”, the Applicant means: molecular polyfunctional organic reagents with a carbon-based chain containing at least 9 carbon atoms, preferentially at least 20 carbon atoms; and also macromolecular polyfunctional organic reagents of natural or synthetic origin; these two types of polyfunctional reagents being chosen from those which bear functional groups of carboxylic acid, amine or cyanate type.

The macromolecular polyfunctional reagents that are useful for the invention have a degree of polymerization of greater than or equal to 5, preferentially 10, and a number-average molecular weight of at least 1000 g/mol, preferentially 4000 g/mol, and a weight-average molecular weight of at least 10000 g/mol, preferentially 50000 g/mol.

A crosslinking system according to the invention is composed of at least one short-distance crosslinking agent and of at least one polyhydroxylated polymer By the term “polyhydroxylated polymer”, the Applicant means polymers bearing at least two alcohol functional groups.

The crosslinking system makes it possible to connect the macromolecular chains of the polysaccharide material via bridges of selected length having molecular flexibility.

A short-distance crosslinking agent molecule can become attached to the polysaccharide material via one of its reactive functions, and then become attached to the polyhydroxylated polymer via another of its reactive functions. The crosslinking agent molecule thus creates a bonding bridge between the polysaccharide material and the hydroxylated polymer. Without the short-distance crosslinking agent, the hydroxylated polymer cannot bond with the polysaccharide material since the hydroxyls of the alcohol functional groups cannot react with the hydroxyls borne by the polysaccharide material. By repeating the bonding operation between one hydroxyl of another polysaccharide chain of the polysaccharide material and another hydroxyl of the polyhydroxylated polymer, intermolecular bonding between two polysaccharide chains can be created. The repetition of creation of bonds between the polysaccharide chains leads to solid attachment of these chains to each other.

The size of the polyhydroxylated polymer and the distribution of the alcohol functions on this polymer are parameters that can be varied to modulate the effects of the solid attachment of the polysaccharide chains.

According to a crosslinking variant with a long-distance crosslinking system, homogeneous mixing of the polysaccharide material and of the polyhydroxylated polymer is performed before introducing the short-distance crosslinking agent. This crosslinking variant is performed in two steps. First, the polyhydroxylated polymer is introduced into the polysaccharide material under stirring conditions enabling homogeneous mixing between these two materials, and the stirring may be maintained for a time that is sufficient to ensure the production of a homogeneous mass. Second, the short-distance crosslinking agent is introduced with stirring which ensures rapid dispersion.

In a first variant of a long-distance crosslinking system, the polyhydroxylated polymer is chosen from polymers or copolymers consisting of monomers with molecular weights of greater than or equal to 40 g/mol. According to this variant, their degree of polymerization is greater than or equal to 10, preferentially greater than or equal to 50 and most preferentially greater than or equal to 80. Also according to this variant, their degree of polymerization may be less than or equal to 200, preferentially less than or equal to 150 and most preferentially less than or equal to 100.

Synthetic polymers that are useful for this variant of the invention as polyhydroxylated polymers are: aliphatic polyethers of low molar mass, such as paraformaldehyde, polyethylene glycol, polypropylene glycol or polytetramethylene glycol, or of high molar mass, such as polyoxymethylene, polyethylene oxide or polytetrahydrofuran; polyvinyl alcohols, such as poly(vinyl alcohol); linear or branched polyether polyols, such as polyglycerol; polymers of carboxylic acid such as lactic acid or glycolic acid.

Synthetic copolymers that are useful for the invention as long-distance crosslinking agent are copolymers of ethylene and vinyl alcohol.

In a second variant of crosslinking system, the polyhydroxylated polymer is chosen from polymers or copolymers consisting of monomers with molecular weights of greater than or equal to 160 g/mol. According to this variant, the degree of polymerization is then greater than or equal to 5, preferentially greater than or equal to 25 and most preferentially greater than or equal to 50. Furthermore, still according to this variant, their degree of polymerization may be less than or equal to 200, preferentially less than or equal to 150 and most preferentially less than or equal to 100.

Polymers that are useful in this variant of the invention as polyhydroxylated polymers are oligosaccharides, maltodextrins or dehydrated glucose syrups, obtained from the acid or enzymatic hydrolysis of starch of a botanical origin chosen from the possible botanical origins of the starchy material according to the invention.

Among the oligosaccharides that are useful in the invention are, in general, fructooligosaccharides, galactooligosaccharides, glucooligosaccharides, mannan-oligosaccharides and maltooligosaccharides. According to several variants, the oligosaccharides that are useful for the invention are those composed of at least 5 monosaccharides, and of at most 25 monosaccharides.

Maltodextrins are oligosaccharide variants that are useful in the invention as long-distance crosslinking agent. Maltodextrins are obtained by acid and/or enzymatic hydrolysis of starch in an aqueous phase. In general, maltodextrins have a degree of polymerization ranging from 2 to 20.

The dehydrated glucose syrups that are useful for the invention are those composed of glucose polymers with a degree of polymerization of greater than or equal to 26, preferentially greater than or equal to 50. Examples of dehydrated glucose syrups that are useful in the invention include the Glucidex® products sold by Roquette Frères.

According to one variant of the crosslinking step, the implementation of the crosslinking may consist of the simultaneous reaction of all of the crosslinking agents with the polysaccharide material, or of successive reactions, one crosslinking agent after the other. According to another variant, a long-distance crosslinking is performed first, via a long-distance crosslinking agent or a long-distance crosslinking system, and a short-distance crosslinking is performed second, via a short-distance crosslinking agent.

As regards its implementation, the long-distance crosslinking is performed by adding a dose of long-distance crosslinking agent to the chemically functionalized polysaccharide material, at a temperature of at least 20° C., for a reaction time of at least 60 minutes, while at the same time ensuring homogeneous stirring of the mass of polysaccharide material, and rapid dispersion of the crosslinking agents in this mass of modified polysaccharide material.

The dose of long-distance crosslinking agent to be used during the crosslinking is expressed as dry mass of crosslinking agent to be introduced into the reaction medium, relative to the dry mass of polysaccharide material initially engaged in the modification process according to the invention. This dose is within a range extending from 1% to 15% of dry mass of long-distance crosslinking agent relative to the dry mass of polysaccharide material, preferentially in a range extending from 2.5% to 10%. According to one variant of the long-distance crosslinking, the temperature of the reaction medium during the long-distance crosslinking is greater than or equal to 35° C., preferentially greater than or equal to 50° C.

According to another variant of the long-distance crosslinking, the reaction time is greater than or equal to 5 hours, preferentially greater than or equal to 10 hours, and most preferentially greater than or equal to 15 hours.

According to one variant of crosslinking with a long-distance crosslinking system, the dose of polyhydroxylated polymer ranges from 1% to 15% by dry mass of polyhydroxylated polymer relative to the dry mass of polysaccharide material, preferentially in a range extending from 2.5% to 10%. The dose of short-distance crosslinking agent may range from 100 ppm to 10000 ppm of dry mass of short-distance crosslinking agent relative to the dry mass of polysaccharide material, preferentially in a range extending from 2500 ppm to 5000 ppm. This crosslinking variant is performed: at a temperature of at least 20° C., preferentially greater than or equal to 35° C. and most preferentially greater than or equal to 50° C.; fora reaction time of at least 60 minutes, preferentially greater than or equal to 5 hours, most preferentially greater than or equal to 10 hours and even more preferentially greater than or equal to 15 hours.

Placing in Final Solid Form

The colloidal solution of functionalized and crosslinked gelatinized polysaccharide material obtained on conclusion of the chemical modification reactions is transformed into a powder via any drying technique known to those skilled in the art.

According to the variant in which the polysaccharide material is a starchy material, it may be a matter of drying on a drying drum or in a recirculating flash evaporator. The modified starchy material powder obtained on conclusion of the drying has a particle size characterized by a volume-mean diameter, measured by dry-route laser scattering, ranging from 10 μm to 1 mm, preferentially from 10 μm to 500 μm and most preferentially between 20 μm and 50 μm. If necessary, a milling operation may be applied to the powder exiting the drying operation, so as to achieve the desired particle size.

The powder obtained is substantially totally amorphous, and is thus soluble in cold water, i.e. water at a temperature of between 5° C. and 30° C.

Four variants of the process according to the invention using a base starchy material are presented hereinbelow.

According to a first variant of the process according to the invention, the modified starchy material prepared is a hydroxypropylated potato starch with a degree of substitution ranging from 0.10 to 0.50, preferentially ranging from 0.15 to 0.30.

This modified starch variant is prepared using, as base starch, a native potato starch. This native starch is then totally dissolved with stirring by heating to 80° C. in the presence of sodium hydroxide at a content ranging from 1% to 5% of dry sodium hydroxide/dry starch, preferentially ranging from 1.5% to 2%. The viscosity of the aqueous starch solution is within a range extending from 100 to 1000000 mPa·s, preferentially ranging from 500 to 200000 mPa·s and most preferentially ranging from 1000 to 50000 mPa·s. The dissolved starch is then hydroxypropylated by adding propylene hydroxide until a degree of substitution ranging from 0.10 to 0.50 and preferentially ranging from 0.15 to 0.30 is achieved. The aqueous solution of hydroxypropylated starch thus obtained has a Brookfield viscosity ranging from 4000 to 30000 mPa·s, preferentially from 5000 to 24000 mPa·s, at 20° C. at 20 rpm.

According to a second variant of the process according to the invention, the modified starchy material prepared is a potato starch which has been: hydroxypropylated to a degree of substitution ranging from 0.10 to 0.50, preferentially ranging from 0.15 to 0.30; and crosslinked with the short-distance crosslinking agent which is sodium trimetaphosphate, used at a dose ranging from 100 ppm to 2000 ppm.

This second process variant consists in performing dissolution and hydroxypropylation in an identical manner to the preceding first variant, followed by performing crosslinking in the presence of sodium trimetaphosphate at a dose ranging from 100 ppm to 2000 ppm at a temperature of between 25° C. and 50° C., for a reaction time of between 15 hours and 30 hours.

The aqueous solution of hydroxypropylated and crosslinked starch obtained has a Brookfield viscosity ranging from 4000 to 30000 mPa·s, preferentially from 5000 to 24000 mPa·s, at 20° C. at 20 rpm.

According to a third variant of the process according to the invention, the modified starchy material prepared is a potato starch which has been: hydroxypropylated to a degree of substitution ranging from 0.10 to 0.50, preferentially ranging from 0.15 to 0.30; and carboxymethylated to a degree of substitution ranging from 0.05 to 1, preferentially ranging from 0.05 to 0.15.

The implementation of this third variant consists of dissolution and hydroxypropylation according to the first variant presented previously, followed by carboxymethylation with sodium monochloroacetate under sodium hydroxide catalysis until a degree of substitution ranging from 0.01 to 0.5, preferentially from 0.05 to 0.15 is reached. The carboxymethylation is performed at a temperature of between 50° C. and 100° C., preferentially between 70° C. and 90° C., for a reaction time of between 1 hour and 10 hours, preferentially between 4 hours and 7 hours.

The aqueous solution of hydroxypropylated and carboxymethylated starch obtained has a Brookfield viscosity ranging from 5000 to 300000 mPa·s, preferentially from 15000 to 85000 mPa·s, at 20° C. at 20 rpm.

According to a fourth variant of the process according to the invention, a modified starch is a hydroxypropylated and carboxymethylated potato starch crosslinked with sodium trimetaphosphate. The degree of hydroxypropyl substitution ranges from 0.10 to 0.50 and preferentially from 0.15 to 0.30. The degree of carboxymethyl substitution ranges from 0.01 to 0.5 and preferentially from 0.05 to 0.15. The degree of crosslinking ranges from 100 ppm to 2000 ppm, preferentially from 500 ppm to 1500 ppm.

This modified starch variant is prepared using, as base starch, a native potato starch. This native starch is totally dissolved with stirring by heating to 80° C. in the presence of sodium hydroxide at a content ranging from 1% to 5% of dry sodium hydroxide/dry starch, preferentially ranging from 1.5% to 2%. The viscosity of the aqueous starch solution is within a range extending from 100 to 1000000 mPa·s, preferentially ranging from 500 to 200000 mPa·s and most preferentially ranging from 1000 to 50000 mPa·s. The dissolved starch is then hydroxypropylated by adding propylene hydroxide until a degree of substitution ranging from 0.10 to 0.50 and preferentially ranging from 0.15 to 0.30 is achieved. The starch is then carboxymethylated by reaction with sodium monochloroacetate under sodium hydroxide catalysis until a degree of substitution ranging from 0.01 to 0.5 and preferentially from 0.05 to 0.15 is achieved. The starch is finally crosslinked in the presence of sodium trimetaphosphate at a dose ranging from 100 ppm to 2000 ppm at a temperature of between 25° C. and 50° C. for a reaction time of between 15 hours and 30 hours.

The aqueous solution of hydroxypropylated, carboxymethated and crosslinked starch obtained has a Brookfield viscosity ranging from 4000 to 30000 mPa·s, preferentially from 5000 to 24000 mPa·s and most preferentially from 8000 to 15000 mPa·s, at 20° C. at 20 rpm.

Devices for Performing the Process

The devices that are useful for performing the process according to the invention are stirred reactors that are capable of performing homogeneous mixing of viscous media, preferentially by pumping and under moderate shear, and most preferentially by pumping and under low shear. In general, any reactor equipped with stirring devices including at least one stirring rotor of single-screw, corotating or counter-rotating twin-screw or plowshare type, alone or in combination with axial/radial mixed pumping stirring rotors, is suitable for stirring a viscous mixture.

The dissolution step may be performed in a “jet cooker” and the dissolved starch is then transferred into a stirred reactor, where the homogeneous chemical functionalization is performed. According to one variant, the dissolution and the homogeneous chemical functionalization are performed in the same stirred reactor.

The process may be performed according to batch, semicontinuous or continuous functioning, or a combination of these modes. Each step of the process or each chemical modification may be performed according to one of these modes of functioning of the reactor. Several types of stirred reactor may thus be alternatively used for performing the process according to the invention: conventional stirred-tank type batch reactor; batch reactor with a horizontal cylindrical drum, such as the Druvatherm® DVT reactor from Lödige; tubular continuous reactor equipped with static mixers, such as the SMV™ or SMX™ Plus machines from Sulzer; extruder.

Effect of the Process According to the Invention

The Applicant estimates that, due to the fact that the chemical substitution reactions are performed on a dissolved starch, the chemical groups introduced are uniformly distributed on the starch chains. By means of these adhesive-phase modifications, the chemical groups are probably distributed more homogeneously on the starch chains. This novel distribution of the chemical groups quite probably contributes toward the application properties of the starch according to the invention.

Polysaccharide Material Obtained by Means of the Process and Characterized by the Distribution of the Substituents on Positions 2, 3 and 6

The polysaccharide material obtained by means of the process according to the present invention is characterized by an entirely surprising distribution of the chemical functional groups introduced. By means of an analytical method such as proton nuclear magnetic resonance, the Applicant has in fact found that the process according to the invention makes it possible to obtain a polysaccharide material which has a different chemical functionalization from that of the prior art process as regards the positions of the substituted hydroxyl groups.

The constituent unit of the polysaccharide material is an anhydroglucose or anhydrofructose ring, preferentially an anhydroglucose ring (denoted AGU), as in the following formula:

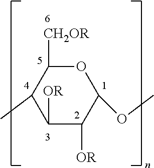

On this unit, the atoms constituting the ring are conventionally numbered from 1, for the “anomeric” carbon atom, to 6, for the carbon atom located outside the ring, as indicated in FIG. 1. The polysaccharide material consists of a sequence of these units connected together by formation of an ether bond between a hydroxyl borne by carbon 1 and a carbon of another unit either in position 4 or in position 6. All the constituent groups bear three hydroxyl functional groups that are available to be substituted by chemical reaction: one in position 2, one in position 3 and one in position 6.

By means of the process according to the invention, the substituent chemical groups attached to the hydroxyl functional groups of the modified polysaccharide material are distributed differently than for a polysaccharide material modified by means of the processes of the prior art.

When it is the first chemical modification performed on the polysaccharide material, preferentially when it is a hydroxyalkylation, and very preferentially a hydroxypropylation, the Applicant has in fact observed, by proton NMR measurement, that the hydroxyalkyl chemical groups are distributed in the following manner: fewer on position 2, more on positions 3 and 6, when compared with a chemical modification according to a granular process.

When it is the second chemical modification performed on the polysaccharide material, preferentially when it is a carboxyalkylation, and very preferentially a carboxymethylation, the Applicant has in fact observed, by proton NMR measurement, that the carboxyalkyl chemical groups are distributed in the following manner: more on position 2, fewer on position 3 and more on position 6, when compared with a chemical modification according to a mixed (i.e. granular-adhesive) process.

Thus, according to a first main embodiment, one subject of the present patent application is the modified polysaccharide material including anhydroglucose units, which is totally water-soluble, including hydroxyl functional groups substituted with at least one hydroxyalkyl chemical group, having a distribution of said hydroxyalkyl group on the constituent units of the polysaccharide material, measured by proton NMR, which is:
a. the percentage of hydroxyalkyl group attached in position 2 is less than or equal to 68%, preferentially less than or equal to 65%, very preferentially less than or equal to 64%,
b. and/or the percentage of hydroxyalkyl group attached in position 3 is greater than or equal to 15%, preferentially greater than or equal to 17%, very preferentially greater than or equal to 17.5%,
a. and/or the percentage of hydroxyalkyl group attached in position 6 is greater than or equal to 15%, preferentially greater than or equal to 17%, very preferentially greater than or equal to 18%.

Preferentially, the modified polysaccharide material is a modified starch, and the distribution of the hydroxyalkyl group is on the anhydroglucose units, as described previously.

According to a second main embodiment, one subject of the present patent application is a modified polysaccharide material according to the first main embodiment, including hydroxyl functional groups substituted with at least one carboxyalkyl chemical group, having a distribution of said carboxyalkyl group on the constituent units of the polysaccharide material, measured by proton NMR, which is:
a. the percentage of carboxyalkyl group attached in position 2 is greater than or equal to 75.5%, preferentially greater than or equal to 76.5%,
b. and/or the percentage of carboxyalkyl group attached in position 3 is less than or equal to 20%, preferentially less than or equal to 19%,
c. and/or the percentage of carboxyalkyl group attached in position 6 is greater than or equal to 4%, preferentially greater than or equal to 5%.

Preferentially, the modified polysaccharide material is a modified starch, and the distribution of the hydroxyalkyl group is on the anhydroglucose units, as described previously.

According to a preferential variant of the two main embodiments of the modified polysaccharide material that is the subject of the present invention, the modified polysaccharide material includes hydroxyalkyl groups chosen from hydroxypropyl or hydroxyethyl, preferentially hydroxypropyl. Very preferentially, the hydroxyalkyl group is a hydroxypropyl group, and the degree of hydroxypropyl substitution is between 0.05 and 2, preferentially between 0.1 and 1, most preferentially between 0.15 and 0.6 and more preferentially between 0.15 and 0.5.

According to a preferential variant of the second main embodiment, the variant with carboxyalkyl groups, the modified polysaccharide material includes as carboxyalkyl group a carboxymethyl group. Very preferentially, the degree of carboxymethyl substitution is between 0.03 and 2, preferentially between 0.03 and 1, most preferentially between 0.03 and 0.3 and more preferentially between 0.03 and 0.2.

According to a preferential variant of the main embodiments and preceding preferential variants, the modified polysaccharide material according to the invention is crosslinked with a crosslinking agent chosen from long-distance crosslinking agents or short-distance crosslinking agents, and preferentially from short-distance crosslinking agents, and most preferentially with sodium trimetaphosphate.

According to a preferential variant of the main embodiments and preceding preferential variants, the modified polysaccharide material is in the form of a powder which has a volume-mean diameter, measured by dry-route laser scattering, of between 10 μm and 1 mm, preferentially between 50 μm and 500 μm. Very preferentially, the modified polysaccharide material is soluble without heating, and most preferentially substantially totally amorphous.

The method for measuring the distribution of the hydroxyalkyl and carboxyalkyl substituents on positions 2, 3 and 6, i.e. on the hydroxyls in positions 2, 3 and 6 of the constituent units of the modified polysaccharide material, preferentially on the anhydroglucose units of the modified starch, is a proton nuclear magnetic resonance measurement at 25° C., which is known per se.

The analysis may be done in deuterium oxide solvent, D₂O, with a purity of at least 99.8%, and deuterium chloride, DCI, on a Bruker Spectrospin Avance Ill spectrometer, operating at 400 MHz, using NMR tubes 5 mm in diameter.

For example, such a method may be adapted from the published method “Determination of the level and position of substitution in hydroxypropylated starch by high-resolution 1H-NMR spectroscopy of alpha-limit dextrins”, from A. Xu and P. A. Seib, in the Journal of Cereal Science, vol. 25, in 1997, on pages 17 to 26, as regards the identification of the signals of the NMR spectrum, without performing the enzymatic attack for production of the alpha-limit dextrins.

When the polysaccharide material is modified with only one chemical group, then the NMR method is applied, for example, as illustrated in example 7 for the hydroxypropyl group.

When the polysaccharide material is modified with at least two chemical groups, the NMR method must be applied on samples isolated after each modification, to be able to subtract the signals of the protons of the preceding modifications from those of the modification under study. An example of this case in point is illustrated in example 7 on a starch which is firstly hydroxypropylated and secondly carboxymethylated.

The determination of the degrees of substitution with hydroxyalkyl or carboxyalkyl groups is possible by proton nuclear magnetic resonance. For example, for the hydroxypropyl substituents, the reference method EN ISO 11543:2002 F may be employed.

Industrial Application: Organic Adjuvant for Dry Mortars

The starches modified according to the process of the present invention may have at least three types of chemical substituents typically used in the field of modified starches as additives for construction materials: hydroxypropyl substituents, carboxymethyl substituents and crosslinking with trimetaphosphate, and these substituents may be present at low degrees of substitution, for example less than or equal to 0.3. Contrary to the knowledge of the prior art, the low contents of these substituents make it nevertheless possible to obtain a dry product which imparts excellent properties to dry mortars. By incorporating the modified starch according to the invention into dry mortar formulations, adhesives are obtained which have excellent sliding resistance and refractoriness, while at the same time having an acceptable open time and setting time.

The modified starch powders according to the invention may be used as organic adjuvant in dry mortars, which are either cement-based or gypsum-based. In particular, they may be used in adhesive mortars for tiling, and also in spraying plasters and in plasterboard plasters. The modified starches according to the invention show good adaptability with respect to the nature of the mineralogical binder.

Dry mortars are mixed with water to form a mix, which is an aqueous suspension of the components of the dry mortar. This mix constitutes the adhesive mortar per se, which is used for bonding the elements of a construction, such as bricks, floor slabs or tiles.

In general, dry mortars are mixtures of dry powders consisting of mineralogical binders, aggregates and organic adjuvants.

The mineralogical binders are the main component. They give the adhesive its fundamental mechanical strength and stability features. They may be hydraulic binders, such as natural or artificial cements, or hydraulic lime. They may also be aerial binders, such as fat or lean aerial limes. Mixtures of hydraulic binders or of aerial binders are also possible.

Aggregates are mineral grains, known as fillers, sands, crushed stones or gravel, according to their size.

Organic adjuvants are organic materials of natural or synthetic origin, which are added to dry mortar in small proportion, generally less than 5% of the weight of the dry mortar, in order to improve the properties of mortars in the fresh state and of mortars in the hardened state. As regards adhesive mortars, the adjuvants may modify the rheological, workability, binding force, setting, hardening or adaptability properties thereof or protect them against desiccation. As regards mortar in the hardened state, the adjuvants may modify the mechanical strength, the frost resistance or the water resistance thereof.

As organic adjuvants for gypsum-based or cement-based dry mortars, the Applicant has found that the modified starches obtained by means of the process according to the invention make it possible notably to increase the binding force of the fresh mortar, and to a certain extent of the hardened mortar, and that they have good thickening power, all this being with lower degrees of substitution than the values of the modified starches of the prior art.

In the case of a cement-based adhesive mortar for tiling, the modified starches according to the invention allow various improvements according to the applied chemical functionalization. An application test making it possible to demonstrate the differences between the starches produced according to the prior art and those according to the process of the invention is the measurement of the sliding resistance.

The sliding resistance is generally evaluated by measuring the distance covered following the vertical movement downward, expressed in millimeters, of a tiling tile bonded to a vertical support, a period of 20 minutes after placing the tile at the top of the bonding surface. It is a matter of sliding along the vertical support. The shorter the distance, the greater the sliding resistance. By replacing the starches of the prior art with the modified starches according to the invention in a tiling dry mortar composition, the distance covered by sliding is reduced by at least 30%, preferentially 78%.

For a chemical functionalization consisting solely of hydroxypropylation, the process according to the invention makes it possible to achieve an acceptable sliding resistance, notably sliding of less than 2 mm, for a degree of substitution that is half that of a hydroxypropylated starch according to the process of the prior art, which gives sliding of more than 62 mm. Furthermore, when the base polysaccharide material is a mixture of potato starch and pea starch, the process according to the invention succeeds in chemically functionalizing the pea starch, so that a fresh mortar prepared with this mixture of modified starches gives a sliding resistance equivalent to that of a modified starch based only on potato.

When the chemical functionalization consists of hydroxypropylation followed by carboxymethylation, the process of the invention makes it possible to reduce by more than 50% the degrees of substitution required obtain a sliding resistance equivalent to that of starches prepared according to the process of the prior art.

Finally, when the chemical functionalization consists of hydroxypropylation followed by carboxymethylation and crosslinking with sodium trimetaphosphate, the process according to the invention makes it possible, surprisingly and entirely unexpectedly, to obtain a modified starch which gives an acceptable sliding resistance, whereas a starch modified according to the process of the prior art does not give any sliding resistance.

When compared with the modified starches of the prior art which are substituted to high degrees of substitution, generally greater than 0.5 or even 1, the starches modified according to the process of the invention have the advantage of having lower degrees of substitution, of less than or equal to 0.3, preferentially less than or equal to 0.2. These low degrees of substitution make it possible to reduce the environmental impact of the production process, notably by reducing the amounts of reagents required to modify the starches.

In addition to this improvement of their binding force, the adhesive mortars prepared with the starches according to the invention have application properties equivalent to those of the products of the prior art, notably in terms of workability, open time and setting time.

It is known that sugar is a setting-time retardant. For this reason, the use of modified starch as organic adjuvant in mortars leads to an increase in the setting time, when compared with starch-free mortars, which must nevertheless remain less than 24 hours to be acceptable. The mortars prepared with the starches modified according to the process of the invention effectively have a setting onset time of less than 24 hours.

By means of the starches modified according to the process of the invention, it is also possible to obtain an efficient adhesive mortar for a mix water content of between 0.65 and 0.75, preferentially between 0.68 and 0.72, while at the same time conserving an acceptable setting time, of less than 24 hours.

In the case of gypsum-based dry mortars for plasterboards, the starches modified by means of the process according to the invention have acceptable thickening properties, as demonstrated by a test of spreading of a plaster consisting of gypsum, modified starch and water.

### FIGURES

FIG. 1: location of the hardness measurement points on a plasterboard

FIG. 2: graph of comparison of the hardnesses at 5 mm (N) of plasterboards

### EXAMPLES

### Example 1: Preparation of Starch Modified According to the Process of the Prior Art

The example that follows describes the process for preparing a modified starch according to the prior art.

Modification Process:

This example of implementation of the process according to the prior art is performed in a Druvatherm DVT10 reactor from the manufacturer Lödige Process Technology. It is a jacketed, horizontally positioned cylindrical reactor, the stirring device of which is suitable for fluids with a viscosity which may be up to 1000000 mPa·s. The stirring device consists of a main mixer with plowshare paddles arranged along the central horizontal axis, and a secondary mixer with rotating knives arranged close to the inner wall of the reactor. Each mixer can rotate at its own adjustable speed.

For all the operations performed in this example, the stirring is set at 100 rpm for the main mixer and at 1000 rpm for the secondary mixer.

The first step is the preparation of a starch milk. To do this, 2500 g of dry potato starch are spread into 3750 g of water at 39° C., 725 g of sodium sulfate powder are then dissolved in this starch milk and the pH of the milk is adjusted to 8 with aqueous 5% sodium hydroxide solution.

The second step is granular-phase hydroxypropylation, catalyzed with sodium hydroxide, to reach a degree of substitution of 0.25. 800 g of aqueous 5% sodium hydroxide solution, i.e. 40 g of dry sodium hydroxide, are introduced into the milk. This amount of sodium hydroxide is the catalyst for the hydroxypropylation reaction. 260 g of liquid propylene oxide are introduced while maintaining a pressure of less than or equal to 3 bar in the reactor. The reaction medium is then maintained at 39° C. for 16 hours, until the propylene oxide has been totally consumed, without regulating the pressure. During this hydroxypropylation, the starch conserves its granular structure, by means of the sodium sulfate present and at a temperature below the gelatinization temperature of potato starch (about 65° C.).

The third step is the cooking, i.e. gelatinization, of the hydroxypropylated starch to obtain a starch adhesive. The temperature of the reactor is increased to 80° C. and maintained for 60 minutes to obtain a homogeneous adhesive of stable viscosity.

The fourth step of the starch modification is carboxymethylation catalyzed with sodium hydroxide. 803 g of aqueous 50% sodium hydroxide solution, i.e. 401.5 g of dry sodium hydroxide, are introduced into the starch adhesive: this amount of sodium hydroxide is the catalyst for the carboxymethylation. 900 g of dry sodium monochloroacetate are introduced in a single portion into the starch adhesive. The reactor is stirred at 80° C. for 5 hours to reach the end of the reaction.

The next step in the modification of the gelatinized and carboxymethylated hydroxypropylated starch, i.e. the fifth step in this process, is crosslinking catalyzed with the excess sodium hydroxide introduced during the preceding reactions. The crosslinking agent is sodium trimetaphosphate. 2.5 g of this salt are introduced in dry form into the reaction medium. The reactor is stirred at 80° C. for 3 hours.

Drying Protocol:

The modified starch gel obtained on conclusion of the three chemical substitutions is then transformed into a solid by passing through a drying drum from the manufacturer Andritz Gouda, at a spin speed of 7.5 rpm, the cylinders of which are heated to 90-100° C. with steam at 10 bar. Flakes of a solid starch are thus obtained. These flakes are successively milled in a hammer mill from the manufacturer Retsch, equipped with a 2 μm grate, at 1500 rpm, and then in a Septu brand ultra-fine mill set at 50 Hz, at a spin speed of 3000 rpm. This results in a fine whitish powder. The volume-mean diameter of this powder is 37 μm.

The degrees of substitution of the starch are: 0.25 of hydroxypropyl functions, and 0.36 of carboxymethyl functions, and 1000 ppm of trimetaphosphate. This starch is referenced EDT 4.

Three other starches according to the prior art are prepared by partly following the prior art process.

Two starches are prepared by performing the hydroxypropylation, gelatinization and carboxymethylation, but not the crosslinking: EDT 3 is prepared with a degree of hydroxypropyl substitution of 0.2 and of carboxymethyl substitution of 0.1 by using 260 g of propylene oxide and 300 g of sodium monochloroacetate; EDT 2 is prepared with a degree of hydroxypropyl substitution of 0.7 and of carboxymethyl substitution of 0.2 by using 910 g of propylene oxide and 600 g of sodium monochloroacetate. A starch, denoted EDT 1, is prepared by performing only the hydroxypropylation with 650 g of propylene oxide to achieve a degree of substitution of 0.5.

TABLE 1
starches prepared according to the process of the prior art

| | | DS with | DS with | DS with | |
|---|---|---|---|---|---|
| | Base | hydroxy- | carboxy- | tri- | D43 |
| Reference | starch | propyl | methyl | metaphosphate | (μm) |
| EDT 1 | Potato | 0.5 | 0 | 0 | 37 |
| EDT 2 | starch | 0.7 | 0.2 | 0 | 35 |
| EDT 3 | | 0.2 | 0.1 | 0 | 40 |
| EDT 4 | | 0.25 | 0.36 | 1000 | 42 |

### Example 2: Preparation of Starches Modified According to the Process of the Invention

The example that follows describes the process for preparing a modified starch according to the invention.

Modification Process:

This example of implementation of the process according to the invention is performed in a Druvatherm DVT10 reactor from the manufacturer Lödige Process Technology, identical to the reactor used for example 1 of the process according to the prior art.

First, a starch gel is prepared by performing the gelatinization of the native starch under the effect of heat in the presence of sodium hydroxide. To do this, 2500 g of dry potato starch are spread in 5833 g of water at 20° C. with stirring at 100 rpm for the main mixer and at 1000 rpm for the secondary mixer, and the temperature of the reaction medium is then gradually increased to about 80° C. at about 10° C./hour. During this heating, when the temperature reaches 65° C., the stirring speed of the main mixer is increased to 200 rpm and that of the secondary mixer to 2000 rpm, and 80 g of aqueous 50% sodium hydroxide solution are then added to the starch suspension over 5 minutes, i.e. 40 g of dry sodium hydroxide, to facilitate the splitting of the starch grains. After reaching the temperature of 80° C., the starch gel is kept stirring at this temperature for 1 hour to obtain a homogeneous gel. The starch gel obtained does not contain any whole or split grains: the starch is dispersed in its entirety in the form of a hydrocolloid.

Secondly, the chemical modifications are performed, conserving the stirring parameters used previously: namely, a speed of 200 rpm for the main mixer, and a speed of 2000 rpm for the secondary mixer.

The first chemical modification of the gelatinized starch is hydroxypropylation catalyzed with sodium hydroxide. No additional amount of sodium hydroxide is added. 294 g of liquid propylene oxide are introduced while maintaining a pressure of 3 bar in the reactor. The reaction medium is then maintained at 80° C. for 4 hours, until the propylene oxide has been totally consumed. On conclusion of this hydroxypropylation, a starch referenced ROQ 1 may be isolated in solid form by following the drying protocol below.

The second modification is carboxymethylation catalyzed with sodium hydroxide. 214 g of aqueous 50% sodium hydroxide solution, i.e. 107 g of dry sodium hydroxide, are introduced into the starch adhesive: this amount of sodium hydroxide is the catalyst for the carboxymethylation. 240 g of dry sodium monochloroacetate are introduced in a single portion into the starch adhesive. The reactor is stirred at 80° C. for 5 hours to reach the end of the reaction. On conclusion of this carboxymethylation, a starch referenced ROQ 2 is prepared in solid form by following the drying protocol below.

The third modification step is crosslinking catalyzed with the excess sodium hydroxide introduced during the preceding reactions. The crosslinking agent is sodium trimetaphosphate. 2.5 g of this salt are introduced in dry form into the reaction medium. The reactor is stirred at 80° C. for 3 hours. A modified starch ROQ3 is prepared in solid form by following the drying protocol below.

A modified starch ROQ4 is prepared according to the same modification protocol as ROQ 1 above, this time using a potato starch/pea starch mixture in a 50/50 ratio. 1250 g of potato starch are mixed with 1250 g of pea starch for a total of 2500 g of starch. A modified starch ROQ5 is prepared according to the same modification protocol as ROQ3 above, this time using a potato starch/pea starch mixture in a 50/50 ratio. 1250 g of potato starch are mixed with 1250 g of pea starch for a total of 2500 g of starch.

Drying Protocol:

As for the modified starch of example 1, the modified starch gel obtained on conclusion of the three chemical substitutions is then transformed into a solid by the same operations, of drying on a drying drum and of successive milling, as those performed in example 1, resulting in a fine whitish powder. The volume-mean diameter of this powder is 35 μm.

The degrees of substitution of the starch are: 0.2 of hydroxypropyl functions, and 0.1 of carboxymethyl functions, and 1000 ppm of trimetaphosphate.

TABLE 2
starches prepared according to the process of the invention

| | | DS with | DS with | DS with | |
|---|---|---|---|---|---|
| | | hydroxy- | carboxy- | tri- | D43 |
| Reference | Base starch | propyl | methyl | metaphosphate | (μm) |
| ROQ 1 | Potato | 0.2 | 0 | 0 | 35 |
| ROQ 2 | starch | 0.2 | 0.1 | 0 | 37 |
| ROQ 3 | | 0.2 | 0.1 | 1000 ppm | 40 |
| ROQ 4 | 50/50 | 0.2 | 0 | 0 | 38 |
| ROQ 5 | starch | 0.2 | 0.1 | 1000 ppm | 32 |
| | potato/pea | | | | |

### Example 3: Sliding Resistance and Setting Time of Adhesive Mortars

According to the standard NF EN 12004-2: 2017-04, tile adhesives are prepared according to the instructions of paragraph 6, starting with dry mortars of composition chosen by the Applicant to be discriminating between the mortars. These adhesives are used to bond ceramic tiles 10 cm×10 cm in size, in order to compare the sliding resistances thereof, according to the instructions of point 8.2 of said standard.

Preparation of the Dry Mortar:

The composition of the dry mortar is 40 parts of CEM I Portland 52.5N CP2 cement supplied by Equiom, 59 parts of sand 0.1-0.4 μm in size supplied by Société Nouvelle du Littoral, 0.50 part of the redispersible powder Vinnapas 5010N supplied by Wacker, 0.50 part of the cellulose ether Walocel MKX 6000 supplied by Dow, and 0.05 part of modified starch, according to the prior art or according to the invention. The masses of products making it possible to prepare 847.9 g of dry mortar satisfying this composition are given in table 3. All the components are in the form of dry powders.

The required masses of these powders are mixed in a L01.M03 planetary mixer from the manufacturer Euromatest Sintco, at a stirring speed of 140 rpm for the rotor speed and of 62 rpm for the planetary movement, for 15 minutes.

TABLE 3
composition of the dry mortar for tile adhesive

| | | Parts | |
|---|---|---|---|
| | Commercial | by dry | Mass |
| Components | references | weight | (grams) |
| CEM I (Portland) | CEM I - 52.5N - CP2 from Equiom | 40 | 339 |
| 0.1-0.4 μm sand | Société Nouvelle du Littoral | 59 | 500 |
| Redispersible powder | Vinnapas 5010N from Wacker | 0.50 | 4.24 |
| Cellulose ether | Walocel MKX 6000 from Dow | 0.50 | 4.24 |
| Starch | Variable according to the tests | 0.05 | 0.42 |

The 0.1-0.4 μm sand is composed of particles with a diameter ranging from 0.1 μm to 0.4 μm, and the particle size of which is characterized by a D₁₀ of 171 μm, a D₅₀ of 270 μm, a D₉₀ of 418 μm and a D_{4.3} of 284 μm.

Preparation of the Mortar Adhesive (Mixing Operation):

A tile adhesive is prepared from the dry mortar, adhering to a ratio of the mass of water to the mass of cement of 0.7. Thus, 237.3 g of water and 847.9 g of dry mortar prepared according to the composition of table 3 are mixed according to the procedure of point 6 of the standard NF EN 120004-2, the only difference being that only one mixing operation is performed, instead of the two envisaged by the standard. Thus, the mass of water is poured into the tank of an L01.M03 automatic mortar mixer from the manufacturer Euromatest Sintco in accordance with the standard EN 196-1: 2016. The mass of dry mortar is then dispersed in the water, and mixing is then applied for one minute at a spin speed of 285±10 rpm and a planetary movement of 125±10 rpm. On conclusion of this single mixing operation, the adhesive is used immediately in a sliding resistance test.

Method for Measuring the Sliding Resistance

The materials and the apparatus are those of the standard NF EN 12004-2: 2017-04. The adhesive mortars are prepared according to example 3. The procedure is that of paragraph 8.2.3 of said standard.

Implementation of this procedure leads to an amount per unit area of adhesive used ranging from 2.5 to 3.5 kg of adhesive per m² of concrete.

Method for Measuring the Setting Time

The method for measuring the setting time is that described in the standard NF EN 480-2:2006-11, using a PA8 automatic setting meter from the manufacturer Acmel, equipped with a Vicat needle 1.13 mm in diameter and 50 mm long, and a Vicat frustoconical mold with a base diameter of 80 mm, a top diameter of 70 mm and a height of 40 mm. Unlike in the standard, all the steps required for preparing and performing the setting time test are performed in an atmosphere at 23° C.±2° C. and a relative humidity of 50%±5%.

Results:

The sliding values and setting onset time measured for various adhesives prepared from dry mortars differing in the nature of the starch present are presented in table 4.

TABLE 4
comparison of the sliding results measured

| | | | | | | Sliding value | Setting onset |
|---|---|---|---|---|---|---|---|
| | | | | | | measured | time |
| | Starch | | Chemical | | | according to | according |
| Sliding | used | | modifications | | | NF EN | to NF |
| test | in the dry | Starchy | HP | CM | TMPNa | 12004-2 | EN 480-2 |
| reference | mortar | base | (DS) | (DS) | (ppm) | (mm) | (hours) |
| G0 | Without | — | — | — | — | 150 | 16 |
| | starch | | | | | | |
| G1 | EDT 1 | Potato | 0.5 | — | — | 62.7 | 21.8 |
| G2 | EDT 2 | (pot) | 0.7 | 0.2 | — | 6.4 | 19.7 |
| G3 | EDT 3 | | 0.2 | 0.1 | — | 12.7 | n.d. |
| G4 | EDT 4 | | 0.25 | 0.36 | 1000 | 150 | 21 |
| G5 | ROQ 1 | | 0.2 | — | — | 1.7 | 20.7 |
| G6 | ROQ 2 | Potato | 0.2 | 0.1 | — | 7.1 | 15.8 |
| G7 | ROQ 3 | (pot) | 0.2 | 0.1 | 1000 | 4.5 | 17.1 |
| G8 | ROQ 4 | 50/50 | 0.2 | — | — | 1.7 | n.d. |
| G9 | ROQ 5 | pot/pea | 0.2 | 0.1 | 1000 | 4.2 | n.d. |

When only hydroxypropylation is performed (tests G1, G5 and G8), the improvement in the sliding resistance is just as large: the modified starch EDT 1 leads to a sliding value of 62.7 mm, whereas the modified starches ROQ1 and ROQ4 give sliding values of 1.7 mm. Such a low sliding value is moreover less than that of the market reference product Casucol 301, which has a sliding value of 6.4 mm.

When the three chemical substitutions are performed (tests G4, G7 and G9), the effect of the process according to the invention relative to the process of the prior art is flagrant: the modified starch EDT4 leads to a maximum sliding value of 150 mm, which is unacceptable, whereas the modified starches ROQ 3 and ROQ 5 both lead to sliding values of 4.5 mm and 4.2 mm, which are entirely acceptable.

### Example 4: Gypsum-Based Spraying Mortar

The modified starches according to the invention may be used as binding organic adjuvant in the gypsum-based spraying mortar formulation according to table 5.

TABLE 5
spraying mortar composition

| | | Parts | |
|---|---|---|---|
| | Commercial | by dry | Mass |
| Components | references (supplier) | weight | (grams) |
| Gypsum | Beta plaster of Paris (Dislab) | 66 | 450 |
| Hydrated lime | a 63 hydrated lime (Lhoist France) | 3 | 20.5 |
| Calcium carbonate | Mikhart 5 - 5 μm (Provencal S.A) | 30 | 204.6 |
| Retardant | Tartaric acid (Merck) | 0.2 | 1.36 |
| Cellulose ether | Culminal ® MHEC 15000 PFR (Ashland) | 0.1 | 0.68 |
| Air entraining agent | Berolan LP-W 1 (Berolan) | 0.01 | 0.070 |
| Light aggregate | Perlite 0-1 mm | 0.8 | 5.5 |
| Starch | Variable according to the test | 0.02 | 0.14 |

The Beta plaster of Paris sold by Dislab® is composed of 60% of beta-calcium sulfate hemihydrate, 20% of anhydrite II and 10% of calcium sulfate dihydrate. It is a fine powder, the particle size of which is characterized by a D₁₀ of 2.9 μm, a D₅₀ of 24.5 μm and a D₉₀ of 99 μm, as measured by dry-route laser scattering particle size analysis on a Malvern Mastersizer particle size analyzer.

All the components of the formulation, stabilized beforehand at 23° C.±2° C. and under an atmosphere at 50%±5% relative humidity, are weighed out in a reclosable 1-liter glass jar.

This powder mixture is homogenized in a L01.M03 planetary mixer from the manufacturer Euromatest Sintco, at a stirring speed of 140 rpm for the rotor speed and of 62 rpm for the planetary movement, for 15 minutes. The dry spraying mortar is thus obtained.

400 g of drinking water at 23° C.±2° C. are placed in another L01.M03 automatic mortar mixer from Euromatest Sintco, in accordance with the standard NF EN 196-1. All 682.85 g of the dry spraying mortar are poured into the water without stirring. Immediately after this addition, the stirring of the mixer is started at a slow speed for 10 seconds, and then at a fast speed for 50 seconds. Following this mixing, the mortar is immediately sprayed onto a concrete wall. The layer of mortar adheres correctly to the concrete support, and does not collapse.

### Example 5: Thickener for Plasterboard Plaster

The starches modified according to the process of the invention have thickening properties for plasterboard plasters. The thickening properties of various modified starches according to the invention are compared according to a Vicat spreading measurement according to paragraph 4.3.2 entitled “Dispersion method” of the standard NF EN 13279-2 (revision of February 2014) entitled “Liants-plâtres et enduits à base de plâtre pour le bâtiment—Partie 2: méthodes d'essais [Binding plasters and plaster-based renderings for construction—Part 2: test methods]”.

Preparation of the Wet Plaster:

The modified starches according to the invention may be used as binding organic adjuvant for forming wet plasters for plasterboards. According to the formulation of table 6, several starches modified according to the process of the invention are tested.

TABLE 6
composition of the plasterboard

| | Commercial | Mass |
|---|---|---|
| Components | references (supplier) | (grams) |
| Gypsum | Beta plaster of Paris (Dislab) | 300 |
| Starch | Variable according to the test | 0.3375 |
| Water | Drinking water | 210 |

A wet plaster is prepared by pouring all of the dry mixture of the components, homogenized beforehand in an L01.M03 planetary mixer from the manufacturer Euromatest Sintco, at a stirring speed of 140 rpm for the rotor speed and 62 rpm for the planetary movement, for 15 minutes, onto a mass of water and mixing using a whisk in a figure-of-eight movement for 45 seconds, in order to obtain a lump-free homogeneous paste. On concluding the mixing, the wet plaster is engaged in the spreading measurement.

Spreading Measurement:

A Vicat frustoconical ring with a base diameter of 75 mm is filled with a wet plaster preparation according to the formulation of table 6, taking care to pour the plaster slowly into the ring so as not to incorporate any air bubbles, and leveling off the free surface with a blade. This filling operation generally takes about 15 seconds. Immediately on conclusion of the filling, the Vicat ring is abruptly raised vertically in order to release the plaster, which can then spread onto the support glass plate, to form a puddle of wet plaster. 15 seconds after removing the ring, the spreading has generally stabilized, and the mean maximum diameter of the puddle of wet plaster is measured.

TABLE 7
comparative of the spreading values measured for starches according to the invention

| | | | Viscosity |
|---|---|---|---|
| | | | according to test |
| Reference of the | | | A: at 10% solids |
| starch used in | Starch/ | Spreading | in water, at 20° C. |
| the plaster | modifications | (mm) | (mPa · s) |
| Without starch | / | 171 | na |
| EDT 5 | Amidon M-B-065 R starch sold by Roquette | 172 | Not available |
| | Freres (native corn starch)/no modification | | |
| ROQ 1 | Potato/hydroxypropylated DS = 0.2 | 78 | 5 000 |
| ROQ 2 | Potato/hydroxypropylated DS = 0.2 and | 138 | 1 300 |
| | carboxymethylated DS = 0.1 | | |
| ROQ 3 | Potato/hydroxypropylated DS = 0.2; | 76 | 500 |
| | carboxymethylated DS = 0.1 and crosslinked | | |
| | TMPNa 1000 ppm | | |
| ROQ 8 | Pea/hydroxypropylated DS = 0.2 | 157 | 23 300 |
| ROQ 9 | Pea/hydroxypropylated DS = 0.2; | 134 | 8800 |
| | carboxymethylated DS = 0.1 | | |
| ROQ 10 | Pea/hydroxypropylated DS = 0.2; | 76 | 2500 |
| | carboxymethylated DS = 0.1 and crosslinked | | |
| | TMPNa 1000 ppm | | |

Without starch or with a native corn starch Amidon M-B-065-R from Roquette Frères, the spreading achieved exceeds 170 mm, which illustrates the total absence of thickening of the wet plaster.

As regards the starches modified using potato starch, the starch ROQ 1 gives a spreading value of 78 mm, i.e. only 3 mm more than the diameter of the Vicat ring base. This demonstrates that a starch modified by means of the process according to the invention, the only chemical modification being a hydroxypropylation with a DS of 0.2, allows strong thickening of the wet plaster. The addition of a carboxymethylation with a DS of 0.1 (starch ROQ 2) gives a spreading value of 138 mm, which demonstrates degradation of the thickening effect. This might be due to the decrease in viscosity of the starch according to test A to 1300 mPa·s. Surprisingly, the addition of a carboxymethylation with a DS of 0.1 and crosslinking with sodium trimetaphosphate at 1000 ppm (starch ROQ 3), makes it possible to regain the thickening power of the starch ROQ 1 which is only hydroxypropylated. This is all the more surprising since the viscosity according to test A of the starch ROQ 3 per se was, however, further decreased to 500 mPa·s relative to ROQ 2. The regain of thickening power is thus not due to the viscosity of the modified starch, but to the interactions once again made possible by virtue of the spatial structure imposed by the crosslinking.

As regards the starches modified using pea starch, the starch ROQ 8 only substituted by hydroxypropylation with a DS of 0.2 leads to a high spreading value, of 157 mm, despite a high viscosity according to test A, of 23300 mPa·s. This spreading value is reduced to 134 mm by addition of a carboxymethylation with a DS of 0.1 (starch ROQ 9). However, for these two starches, there is clearly no thickening effect on the wet plaster. Surprisingly, for the starch ROQ 10 which has additionally undergone crosslinking with 1000 ppm of trimetaphosphate, the spreading value is virtually equal to the diameter of the Vicat ring, which indicates that the wet plaster has virtually not spread, and thus that the thickening power of the starch ROQ 10 is high. This is all the more surprising since the viscosity of the starch ROQ10 according to test A is less than that of the starches ROQ 8 and ROQ9. In the case of the pea starch, the short-distance crosslinking thus made it possible to reveal the thickening power of the triply modified starch: the short-distance crosslinking gave a spatial structure which makes the hydrogen interactions of the hydroxypropyl groups efficient.

### Example 6: Core Reinforcement of Plasterboards

This example illustrates the increase in “core” mechanical strength by the starches according to the invention for plasterboards prepared from the gypsum-based plaster formulation of example 5 (table 6).

One way of characterizing the core mechanical strength of a plasterboard is to measure the force required, expressed in newtons (N), to make a point penetrate therein to a certain depth, such as with an Instron® 9566 reference rheometer. According to this way of working, the Applicant measured the force required for a geometry point of “circular-based pyramid” type to penetrate 5 mm into the plasterboard at a speed of 10 mm/minute, at a temperature of 20° C. The dimensions of the point are: circular base diameter equal to 4 mm, height equal to 2.5 cm, and thickness of the top of the point equal to 1 mm.

The hardnesses of the plasterboards prepared with starches according to the invention, namely the starches ROQ 1 and ROQ 3, are thus compared with the hardnesses of plasterboards prepared without starch, with native starches (corn starch, pea starch) or with a pregelatinized starch (Roquette commercial starch M-ST 310).

Preparation of the Plasterboards:

Plasterboards of length×width×thickness dimensions equal to 15 cm×7.5 cm×1 cm are each prepared according to the following protocol. When starch is added, only one type of starch is added. There is no mixture of starches.

A wet plaster paste is prepared according to the same protocol as in example 5, with a modification included: 0.33 g of accelerator is added to the dry mixture of gypsum and starch. The accelerator is a powder consisting of plaster, obtained from a commercial plasterboard free of its cardboard faces, which has been manually ground with mortar and dried in an oven at 110° C. for 1 hour.

Immediately on conclusion of its preparation, all the approximately 510.67 g of paste is poured in excess onto a rectangular “plasterboard” cardboard placed in a rectangular steel mold, and covering the entire surface of the mold (15×7.5 cm), the assembly resting on a plastic plate. The term “excess” means that the mass of plaster paste is greater than the mass that the mold can receive, which thus ensures that all the available volume is filled with plaster paste. The rectangular cardboard at the bottom of the mold constitutes the lower face of the plasterboard. Once the casting of the plaster in the mold is complete, a rectangular cardboard (15×7.5 cm) is placed on top of the paste, the concave part of the rectangular cardboard being placed in contact with the paste. This second cardboard constitutes the upper face of the plasterboard. A second plastic plate is then placed on top of this rectangular cardboard, so as to cover the entire surface of the mold.

A 10 kg mass is then placed on the upper plastic plate so as to uniformly cover the surface of the upper cardboard face, for a period of 5 minutes. During the application of this mass, the excess mass of plaster paste spills out at the sides. The mass is then removed, and the assembly is then left as is, to rest in a horizontal position for 4 minutes, after which the plasterboard is stripped from the mold and placed on its edge in the vertical position of its longer edge, for 10 minutes. The plate is then dried standing on its edge, in an oven saturated with water, at 180° C. for 20 minutes, and then in another oven not saturated with water, at 110° C. for 20 minutes, and finally in an oven not saturated with water, at 45° C. for 12 hours. The plasterboard thus obtained is stabilized in a room conditioned at 23° C.±2° C. and humidity of 50%±5% for at least 2 days.

Protocol for Measuring the Hardness of the Plasterboard:

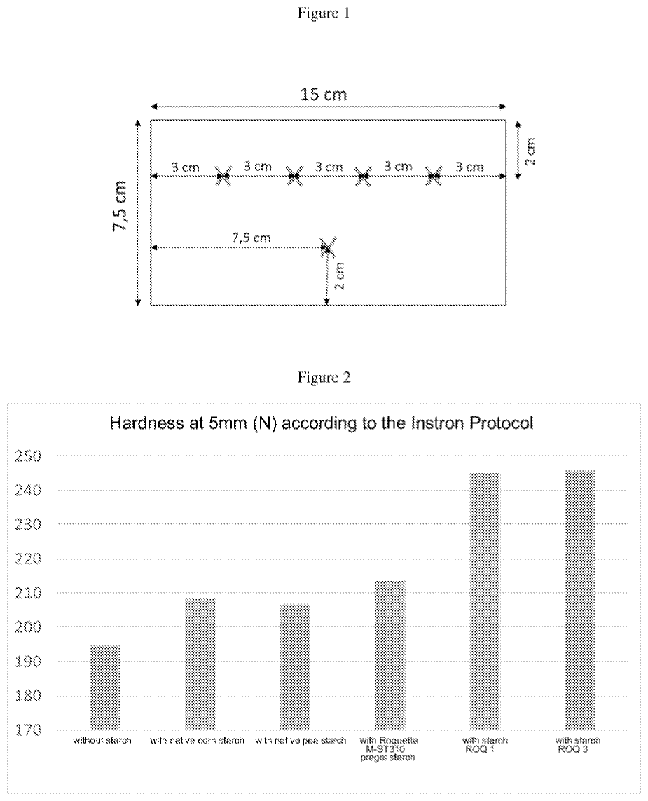

The hardness of each plasterboard is measured by means of the resistance to the penetration of a punch to a depth of 5 mm at a speed of 10 mm/minute with an Instron® 9566 machine. This “5 mm” hardness is expressed in newtons (N). For each plate, five penetration measurements are taken distributed over the surface of the plasterboard according to FIG. 1 so as to take into account any inhomogeneities of the plasterboard: the 5 mm hardness is a mean value of these five measurements, and the standard deviation is given for information (in newtons).

5 mm Hardness Results:

Compared with a plasterboard prepared with a starch-free plaster paste, the results (table 8 and FIG. 2) show an increase in hardness of about 7% by virtue of the addition of native starch to the plaster paste, and of about 10% by virtue of the addition of Roquette M-ST 310 pregelatinized starch. The increase in hardness reaches about 26% with the starches ROQ 1 and ROQ 3 according to the invention. The starches ROQ 1 and ROQ 3 according to the invention are thus efficient for increasing the hardness of a plasterboard, i.e. they make it possible to increase the core mechanical strength of the plasterboard.

TABLE 8
results of the 5 mm hardness measurements

| | 5 mm | Standard |
|---|---|---|
| Nature of | hardness | deviation |
| the starch | (newtons) | (±) |
| Without starch | 194.5 | 13 |
| Native corn starch | 208.5 | 4 |
| Native pea starch | 206.6 | 11 |
| Roquette M-ST 310 | 213.6 | 11 |
| pregelatinized starch | | |
| ROQ 1 starch | 245.1 | 13 |
| ROQ 3 starch | 245.8 | 7 |

### Example 7: Characterization of the Starches According to the Invention by Proton NMR

In this example, it is explained how to exploit proton NMR measurements on a starch which has undergone two successive chemical modifications: in a first stage, a hydroxypropylation, a sample of which, denoted as “Ech_HP”, is analyzed; and then, in a second stage, a carboxymethylation, a sample of which, denoted as “Ech_HP+CM”, is analyzed by means of the preceding analysis of the hydroxypropylated sample “Ech_HP”, notably by subtracting the signals of the H1 protons due to the hydroxypropylation.

The present method is an adaptation of the method disclosed in the article “Determination of the level and position of substitution in hydroxypropylated starch by high-resolution 1H-NMR spectroscopy of alpha-limit dextrins”, from A. Xu and P. A. Seib, published in the Journal of Cereal Science, vol. 25, in 1997, on pages 17 to 26.

Proton NMR Method for the Identification and Quantification of the Positions of the Hydroxypropyl Groups of the Sample Ech HP:

This method is valid for a starch modified only with hydroxypropyls.

The analysis is performed by proton nuclear magnetic resonance, NMR, at 25° C. in deuterium oxide solvent, D₂O, with a purity of at least 99.8%, and deuterium chloride, DCI, on a Brüker Spectrospin Avance III spectrometer, operating at 400 MHz, using NMR tubes 5 mm in diameter.

A solution of sample to be analyzed is prepared by diluting about 15 mg, to within a mg, in 750 microliters of D₂O+100 microliters of 2N DCI, in an NMR tube. The 2N DCI is a solution of deuterium chloride at a double-normality concentration, in deuterium oxide. The sample is heated on a boiling water bath until dissolution is complete and a clear, fluid solution is obtained. The NMR tube is allowed to return to room temperature.

The proton nuclear magnetic resonance spectrum is then acquired at 25° C. at 400 MHz.

With reference to the article by Xu and Seib, the anhydroglucose (denoted as AGU) H1 protons are identified as follows:
at 5.61 ppm and 4.64 ppm: the H1 protons of the alpha-reducing and beta-reducing terminal AGUs,
at 4.95 ppm: the H1 protons of the alpha-(1,6) bonded AGUs,
at 5.67 ppm: the H1 protons of the AGUs whose hydroxyl in position 2 is etherified; the surface area is denoted as S_OR2_HP,
at 5.52 ppm: the H1 protons of the AGUs whose hydroxyl in position 3 is etherified; the surface area is denoted as S_OR3_HP,
at 5.40 ppm: the H1 protons of the AGUs alpha-(1,4) bonded and the H1 protons of the AGUs whose hydroxyl in position 6 is etherified
at 1.15 ppm: this doublet represents the methyl protons of all the attached hydroxypropyl groups; the surface area is denoted as S_CH3_HP,

As stipulated in Xu and Seib, it is considered that the etherification of one hydroxypropyl group with another hydroxypropyl group is negligible. The number of attached hydroxypropyls per 100 AGUs is equal to the surface area S_CH3_HP divided by 3.

The surface area S_OR6 representing the number of H1 protons of the AGUs whose hydroxyl in position 6 is etherified is calculated as follows: S_OR6_HP=(S_CH3_HP)/3−S_OR2_HP−S_OR6_HP.

The sum of the surface areas of the signals of protons H1 whose hydroxyl is etherified, denoted as S_OR_HP_tot, is calculated: S_OR_HP_tot=S_OR2_HP+S_OR3_HP+S_OR6_HP.

The proportions of the three different hydroxypropyl ethers (denoted as HP) as a percentage of the AGU is then calculated:
% of AGU HP-substituted in position 2=100×S_OR2_HP/S_OR_HP_tot
% of AGU HP-substituted in position 3=100×S_OR3_HP/S_OR_HP_tot
% of AGU HP-substituted in position 6=100×S_OR6_HP/S_OR_HP_tot

Proton NMR Method for the Identification and Quantification of the Positions of the Carboxymethyl Groups of the Sample Ech HP+CM:

This method is valid for a starch modified first with hydroxypropyls and then second with carboxymethyls, and whose NMR spectrum after hydroxypropylation and before carboxymethylation was analyzed according to the preceding method (method for Ech_HP).

The analysis is performed by proton nuclear magnetic resonance, NMR, at 25° C. in deuterium oxide solvent, D₂O, with a purity of at least 99.8%, and deuterium chloride, DCI, on a Brüker Spectrospin Avance Ill spectrometer, operating at 400 MHz, using NMR tubes 5 mm in diameter.

A solution of sample to be analyzed is prepared by diluting about 15 mg, to within a mg, in 750 microliters of D₂O+100 microliters of 2N DCI, in an NMR tube. The 2N DCI is a solution of deuterium chloride at a double-normality concentration, in deuterium oxide. The sample is heated on a boiling water bath until dissolution is complete and a clear, fluid solution is obtained. The NMR tube is allowed to return to room temperature.

The proton nuclear magnetic resonance spectrum is then acquired at 25° C. at 400 MHz. With reference to the article by Xu and Seib, the anhydroglucose (denoted as AGU) H1 protons are identified as follows:

With reference to the article by Xu and Seib, the anhydroglucose (denoted as AGU) H1 protons are identified as follows:
at 5.61 ppm and 4.64 ppm: the H1 protons of the alpha-reducing and beta-reducing terminal AGUs,
at 4.95 ppm: the H1 protons of the alpha-(1,6) bonded AGUs,
at 5.67 ppm: the H1 protons of the AGUs whose hydroxyl in position 2 is etherified; the surface area is denoted as S_OR2_HP+CM,
at 5.52 ppm: the H1 protons of the AGUs whose hydroxyl in position 3 is etherified; the surface area is denoted as S_OR3_HP+CM,
at 5.40 ppm: the H1 protons of the AGUs alpha-(1,4) bonded and the H1 protons of the AGUs whose hydroxyl in position 6 is etherified
at 1.15 ppm: this doublet represents the methyl protons of all the attached hydroxypropyl groups; the surface area is denoted as S_CH3_HP,
at 4.22 ppm: this doublet represents the protons of all the attached carboxymethyl groups; the surface area is denoted as S_CH2_CM,

The number of attached hydroxypropyls per 100 AGUs is equal to the surface area S_CH3_HP divided by 3. The number of attached carboxymethyls per 100 AGUs is equal to the surface area S_CH2_CM divided by 2.

The signals OR2 and OR3 representing all of the ethers in positions 2, 3 and 6, whether they are hydroxypropyl or carboxymethyl, are integrated. To determine the amount of carboxymethylated ether for each position, the results obtained for the analysis of the sample that is only hydroxypropylated Ech_HP are taken into account. Thus, the surface areas corresponding to the H1 protons of the AGUs whose hydroxyl is carboxymethylated are thus calculated:
In position 2: S_OR2_CM=S_OR2_HP+CM−S_OR2_HP
In position 3: S_OR3_CM=S_OR3_HP+CM−S_OR3_HP
In position 6: S_OR6_CM=(S_CH3_HP)/3+(S_CH2_CM)/2−S_OR2_CM−S_OR3_CM-S_OR6_HP

The sum of the surface areas of the signals of protons H1 whose hydroxyl is etherified, denoted as S_OR_CM_tot, is calculated: S_OR_CM_tot=S_OR2_CM+S_OR3_CM+S_OR6_CM.

The proportions of the three different carboxymethyl ethers (denoted as CM) as a percentage of the AGU is then calculated:
% of AGU CM-substituted in position 2=100×S_OR2_CM/S_OR_CM_tot
% of AGU CM-substituted in position 3=100×S_OR3_CM/S_OR_CM_tot
% of AGU CM-substituted in position 6=100×S_OR6_CM/S_OR_CM_tot

Comparative Results:

A starch modified by means of the process of the prior art (such as in example 1) by hydroxypropylation to DS 0.26 (denoted as EDT5) is compared with starches prepared by means of the process according to the invention (such as in example 2) by hydroxypropylation to DS 0.20 (denoted as ROQ1) or DS 0.57 (denoted as ROQ 11). The three modified starches were analyzed by means of the proton NMR method for determination of the positions of the substituents on the HP sample. The percentages of hydroxypropyl groups attached in position 2, in position 3 and in position 6 were thus quantified (table 9).

It is found that the starches modified by means of the process according to the invention have a quite different distribution of the hydroxypropyl substituents from that of the starch modified according to the process of the prior art, namely:
Position 2 has a percentage of substitution that is at least 6% lower
Positions 3 and 6 have percentages of substitution that are at least 3% higher.

TABLE 9
comparative of the positions of the hydroxypropyl substituents
according to the prior art and according to the invention

| | Chemical | | Distribution of the hydroxypropyl | | |
|---|---|---|---|---|---|
| | modifications | | groups (proton NMR) | | |
| Reference of the | HP | CM | Position 2 | Position 3 | Position 6 |
| modified starch | (DS) | (DS) | (%) | (%) | (%) |
| EDT5 | 0.26 | — | 70.9 | 14.2 | 14.9 |
| ROQ1 | 0.20 | — | 63.6 | 17.7 | 18.7 |
| ROQ11 | 0.57 | — | 62.6 | 19 | 18.4 |

The starch prepared by means of the process according to the invention (as in example 2) by hydroxypropylation to DS 0.20 (preceding ROQ1) was then modified by carboxymethylation to DS 0.27 (denoted as ROQ 12).

The two modified starches were analyzed by means of the proton NMR method for determination of the positions of the substituents on the HP+CM sample. The percentages of hydroxypropyl groups attached in position 2, in position 3 and in position 6 were thus quantified (table 10).

It is found that the starches modified by means of the process according to the invention have a quite different distribution of the carboxymethyl substituents from that of the starch modified according to the process of the prior art, namely:
Position 2 has a percentage of substitution that is at least 1.5% higher,
Position 3 has a percentage of substitution that is at least 2% lower,
Position 6 has a percentage of substitution that is at least 4% higher.

TABLE 10
comparative of the positions of the carboxymethyl substituents
according to the prior art and according to the invention

| | Chemical | | Distribution of the carboxymethyl | | |
|---|---|---|---|---|---|
| | modifications | | groups (proton NMR) | | |
| Reference of the | HP | CM | Position 2 | Position 3 | Position 6 |
| modified starch | (DS) | (DS) | (%) | (%) | (%) |
| EDT6 | 0.26 | 0.15 | 75 | 20.7 | 3.4 |
| ROQ12 | 0.20 | 0.27 | 76.9 | 18.5 | 8 |

1-15. (canceled)

16. A process for modifying a polysaccharide material including anhydroglucose units, comprising the dissolution, preferentially the total dissolution, of this polysaccharide material, and homogeneous chemical functionalization of the dissolved polysaccharide material, characterized in that:
a. the dissolution is performed before the chemical functionalization,
b. the chemical functionalization consists of a sequence of at least two non-crosslinking esterifications chosen between hydroxyalkylation and carboxyalkylation.

17. The process for modifying a polysaccharide material as claimed in claim 16, wherein a non-crosslinking esterification is a hydroxyalkylation, performed until the polysaccharide material has a degree of substitution of between 0.05 and 2.

18. The process for modifying a polysaccharide material as claimed in claim 17, wherein a non-crosslinking esterification is a hydroxyalkylation performed until the polysaccharide material has a degree of substitution of between 0.1 and 1, preferentially between 0.15 and 0.6.

19. The modified polysaccharide material as claimed in claim 16, wherein a non-crosslinking chemical esterification is a hydroxyalkylation and wherein the hydroxyalkyl group is chosen from hydroxypropyl or hydroxyethyl, preferentially hydroxypropyl.

20. The process for modifying a polysaccharide material as claimed in claim 16, wherein the non-crosslinking esterification is a carboxyalkylation, performed until the polysaccharide material has a degree of substitution of between 0.03 and 2.

21. The process for modifying a polysaccharide material as claimed in claim 16, wherein the non-crosslinking esterification is a carboxyalkylation, performed until the polysaccharide material has a degree of substitution of between 0.03 and 1, preferentially between 0.03 and 0.3.

22. The process for modifying a polysaccharide material as claimed in claim 16, wherein a non-crosslinking chemical esterification is a carboxyalkylation and wherein the carboxyalkyl group is carboxymethyl.

23. The process for modifying a polysaccharide material as claimed in claim 16, wherein the chemical functionalization consists of a sequence of at least two non-crosslinking esterifications wherein the hydroxyalkylation preceeds that carboxyalkylation.

24. The process for modifying a polysaccharide material as claimed in claim 16, wherein a non-crosslinking chemical modification is a hydroxyalkylation, performed until the hydroxyalkyl groups substituting the hydroxyl functions of the anhydroglucose units of the polysaccharide material are distributed in the following manner:
at most 68%, preferentially at most 65%, very preferentially at most 64% in position 2,
and/or at least 15%, preferentially at least 17%, very preferentially at least 17.5% in position 3,
and/or at least 15%, preferentially at least 17%, very preferentially at least 18% in position 6,
the sum of the percentages of the hydroxyalkyl groups substituting the hydroxyl functions being equal to 100% and these percentages being measured by proton NMR.

25. The process for modifying a polysaccharide material as claimed in claim 16, wherein a non-crosslinking chemical modification is a carboxyalkylation, performed until the carboxyalkyl groups substituting the hydroxyl functions of the anhydroglucose units of the polysaccharide material are distributed in the following manner:
at least 75.5%, preferentially at least 76.5% in position 2,
and/or at most 20%, preferentially at most 19% in position 3,
and/or at least 4%, preferentially at least 5% in position 6,
the sum of the percentages of the carboxyalkyl groups substituting the hydroxyl functions being equal to 100% and these percentages being measured by proton NMR.

26. A modified polysaccharide material including anhydroglucose units, preferentially a modified starch, which is totally water-soluble, the hydroxyl functions of said anhydroglucose units being substituted with at least one hydroxyalkyl chemical group and characterized in that the hydroxyalkyl groups substituting the hydroxyl functions are distributed in the following manner:
at most 68%, preferentially at most 65%, very preferentially at most 64% in position 2,
and/or at least 15%, preferentially at least 17%, very preferentially at least 17.5% in position 3,
and/or at least 15%, preferentially at least 17%, very preferentially at least 18% in position 6,
the sum of the percentages of the hydroxyalkyl groups substituting the hydroxyl functions being equal to 100% and these percentages being measured by proton NMR.

27. The modified polysaccharide material as claimed in claim 26, the hydroxyl functions of said anhydroglucose units being substituted with at least one carboxyalkyl chemical group and characterized in that the carboxyalkyl groups substituting the hydroxyl functions are distributed in the following manner:
at least 75.5%, preferentially at least 76.5% in position 2,
and/or at most 20%, preferentially at most 19% in position 3,
and/or at least 4%, preferentially at least 5% in position 6,
the sum of the percentages of the carboxyalkyl groups substituting the hydroxyl functions being equal to 100% and these percentages being measured by proton NMR.

28. The modified polysaccharide material as claimed in claim 26, characterized in that the hydroxyalkyl group is chosen from hydroxypropyl or hydroxyethyl, and is preferentially hydroxypropyl.

29. The modified polysaccharide material as claimed in claim 26, characterized in that the hydroxyalkyl group is a hydroxypropyl group, and characterized in that its degree of hydroxypropyl substitution is between 0.05 and 2, preferentially between 0.1 and 1 and most preferentially between 0.15 and 0.6.

30. The modified polysaccharide material as claimed in claim 26, characterized in that the carboxyalkyl group is carboxymethyl.

31. The modified polysaccharide material as claimed in claim 26, characterized in that its degree of carboxymethyl substitution is between 0.03 and 2, preferentially between 0.03 and 1 and most preferentially between 0.03 and 0.3.

32. The modified polysaccharide material as claimed in claim 26, characterized in that it is in the form of a powder which has a volume-mean diameter, measured by dry-route laser scattering, of between 10 μm and 1 mm, preferentially between 50 μm and 500 μm.

33. The modified polysaccharide material as claimed in claim 26, characterized in that it is soluble without heating, preferentially at least 95% amorphous, more preferentially at least 98% amorphous and most preferentially totally amorphous.

34. A dry mortar composition, preferentially a dry mortar for tile adhesive, and most preferentially a mortar for ceramic tile adhesive, comprising an organic adjuvant comprising the modified polysaccharide material obtained according to the method of claim 16.

35. A gypsum-based mortar, preferentially in a spraying plaster or in a plasterboard plaster, comprising the modified polysaccharide material obtained according to the method of claim 16.
